(19) United States
(12) Patent Application Publication
(10) Pub. No.: US 2025/0370301 A1
(43) Pub. Date: Dec. 4, 2025

(54) LIQUID CRYSTAL PANEL

(71) Applicant: Japan Display Inc., Tokyo (JP)

(72) Inventors: Shunichi KIMURA, Tokyo (JP); Toshiharu MATSUSHIMA, Tokyo (JP); Yuji MAEDE, Tokyo (JP)

(21) Appl. No.: 19/226,464

(22) Filed: Jun. 3, 2025

(30) Foreign Application Priority Data
Jun. 4, 2024 (JP) 2024-090877

(51) Int. Cl. G02F 1/1343

(52) U.S. Cl. CPC G02F 1/134318

(57) ABSTRACT

A liquid crystal panel includes two substrates and a liquid crystal. One of the two substrates includes a first potential gradient forming part positioned inward, a second potential gradient forming part positioned outward, a first electrode provided on an inner periphery side of each of the first and second potential gradient forming parts, a second electrode provided on an outer periphery side thereof, a first transmission part provided with a potential, a second transmission part provided with another potential, a first contact coupling the first electrode and the first transmission part, and a second contact coupling the second electrode and the second transmission part. The second potential gradient forming part includes segments. The first transmission part includes first parts on the first electrodes provided to the segments. The second transmission part includes second parts on the first potential gradient forming part and the second electrodes provided to the segments.

### CROSS-REFERENCE TO RELATED APPLICATION

This application claims the benefit of priority from Japanese Patent Application No. 2024-090877 filed on Jun. 4, 2024, the entire contents of which are incorporated herein by reference.

### BACKGROUND

### 1. Technical Field

What is disclosed herein relates to a liquid crystal panel.

### 2. Description of the Related Art

As disclosed in Japanese Patent Application Laid-open Publication No. 2022-167026, a liquid crystal panel capable of controlling alignment of liquid crystal molecules to produce an optical effect similar to that of a lens has been known.

To make a liquid crystal panel function as a lens, it is needed to form a potential gradient by making potential differ between the inner and outer periphery sides of a circular or annular electrode provided in a light-transmitting region of the liquid crystal panel. The circumferential length is longer on the outer periphery side. Thus, when potential is provided from a single point on the outer periphery side of the electrode, the potential is less likely to be transmitted to positions farther away from the single point, which has sometimes made it difficult to sufficiently provide the potential on the outer periphery side to the entire outer periphery side. Thus, it has been sometimes unable to excellently form a potential gradient due to the potential difference between the inner and outer periphery sides.

For the foregoing reasons, there is a need for a liquid crystal panel capable of more reliably forming a potential gradient.

### SUMMARY

According to an aspect, a liquid crystal panel includes two substrates and a liquid crystal sandwiched between the two substrates. A first substrate that is one of the two substrates includes a first potential gradient forming part positioned relatively inward in a light-transmitting region, a second potential gradient forming part positioned relatively outward in the light-transmitting region, a first electrode provided on an inner periphery side of each of the first potential gradient forming part and the second potential gradient forming part, a second electrode provided on an outer periphery side of each of the first potential gradient forming part and the second potential gradient forming part, a first transmission part to which one of two different potentials is provided, a second transmission part to which the other of the two different potentials is provided, a first contact coupling the first electrode and the first transmission part, and a second contact coupling the second electrode and the second transmission part. Each of the first potential gradient forming part and the second potential gradient forming part is made of an electric conductor having a higher electric resistance than those of the first electrode and the second electrode. The second potential gradient forming part includes a plurality of segments arranged so as to surround the first potential gradient forming part. The first transmission part includes a plurality of first parts stacked on the first electrodes provided to the respective segments. The second transmission part includes a plurality of second parts stacked on the first potential gradient forming part and the second electrodes provided to the respective segments.

### BRIEF DESCRIPTION OF THE DRAWINGS

FIG. 1 is a schematic view illustrating an optical device of an embodiment;

FIG. 2 is a plan view illustrating a schematic structure in a light-transmitting region;

FIG. 3 is a virtual sectional view with one end near the center of the light-transmitting region and the other end at the outer peripheral end of the light-transmitting region;

FIG. 4 is a graph illustrating the relation between the distances of a first region, a second region, and a third region from an optical center and the refractive index differences of light generated by a liquid crystal in the state illustrated in FIG. 3 in the first, second, and third regions;

FIG. 5 is a schematic view illustrating an example of the shapes of a high-resistance film layer and an electrode layer described above with reference to FIG. 3 in a plan view;

FIG. 6 is a schematic view illustrating an example of disposition of contacts described above with reference to FIG. 3 in a plan view and the shape of a transmission part layer in a plan view;

FIG. 7 is a VII-VII sectional view of FIG. 6;

FIG. 8 is a VIII-VIII sectional view of FIG. 6;

FIG. 9 is a IX-IX sectional view of FIG. 6;

FIG. 10 is a X-X sectional view of FIG. 6;

FIG. 11 is an XI-XI sectional view of FIG. 6;

FIG. 12 is a schematic view illustrating an example of disposition of the contacts in a plan view and the shape of the transmission part layer in a plan view in a second embodiment;

FIG. 13 is a XIII-XIII sectional view of FIG. 12;

FIG. 14 is a XIV-XIV sectional view of FIG. 12;

FIG. 15 is a schematic view illustrating an example of disposition of the contacts in a plan view and the shape of the transmission part layer in a plan view in a third embodiment as well as third electrodes provided in the third embodiment;

FIG. 16 is a sectional view illustrating an example of a coupling configuration between a third electrode 332c and a second high-resistance film 322 and between a third electrode 333c and a third high-resistance film 323;

FIG. 17 is a XVII-XIVII sectional view of FIG. 15;

FIG. 18 is an XVIII-XIVIII sectional view of FIG. 15;

FIG. 19 is a XIX-XIX sectional view of FIG. 15;

FIG. 20 is a XX-XX sectional view of FIG. 15;

FIG. 21 is an enlarged view of part FC1 in FIG. 15;

FIG. 22 is a XXII-XXII sectional view of FIG. 21;

FIG. 23 is a XXIII-XXIII sectional view of FIG. 21;

FIG. 24 is a XXIV-XXIV sectional view of FIG. 21;

FIG. 25 is an enlarged view of part FC2 in FIG. 15;

FIG. 26 is a diagram illustrating a modification of a first embodiment;

FIG. 27 is a diagram illustrating a modification of the second embodiment; and

FIG. 28 is a diagram illustrating a modification of the third embodiment.

### DETAILED DESCRIPTION

Embodiments of the present disclosure will be described below with reference to the accompanying drawings. What is disclosed herein is only an example, and any modifications that can be easily conceived by those skilled in the art while maintaining the main purpose of the disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

### First Embodiment

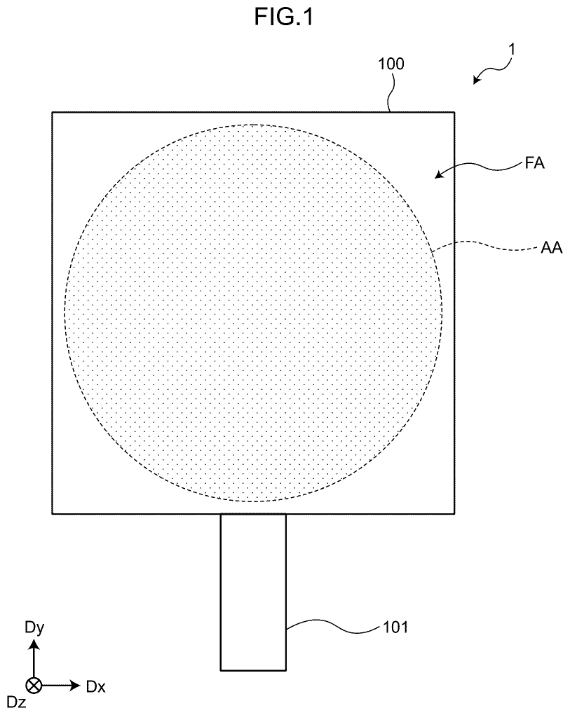

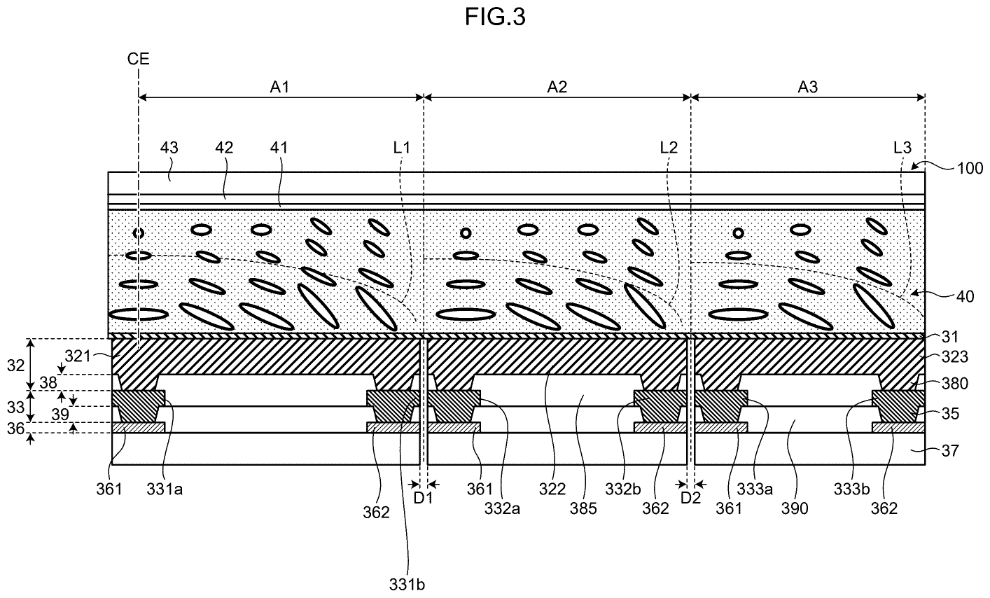

FIG. 1 is a schematic view illustrating an optical device 1 of an embodiment. The optical device 1 includes a liquid crystal panel 100 and a flexible substrate 101. The liquid crystal panel 100 is a liquid crystal panel in which a liquid crystal 40 (refer to FIG. 3) is sealed. The flexible substrate 101 includes a plurality of wires coupling the liquid crystal panel 100 to an external control device.

In description of the embodiment, a first direction Dx refers to a direction along the surface of the liquid crystal panel 100. A second direction Dy refers to a direction along the surface of the liquid crystal panel 100 and orthogonal to the first direction Dx. A third direction Dz refers to a direction orthogonal to the first direction Dx and the second direction Dy.

As illustrated in FIG. 1, the liquid crystal panel 100 includes a light-transmitting region AA and a peripheral region FA. The light-transmitting region AA is a region having a circular edge in a plan view, for example. The peripheral region FA is a region surrounding the edge of the light-transmitting region AA in a plan view. A plan view is a view in which the surface of the liquid crystal panel 100 is viewed from a viewpoint in front of the surface. The light-transmitting region AA is a region controlled such that the light-transmitting region A transmits light traveling from one surface side of the liquid crystal panel 100 toward the other surface side when the optical device 1 is in operation. The peripheral region FA is provided such that the peripheral region FA does not transmit light.

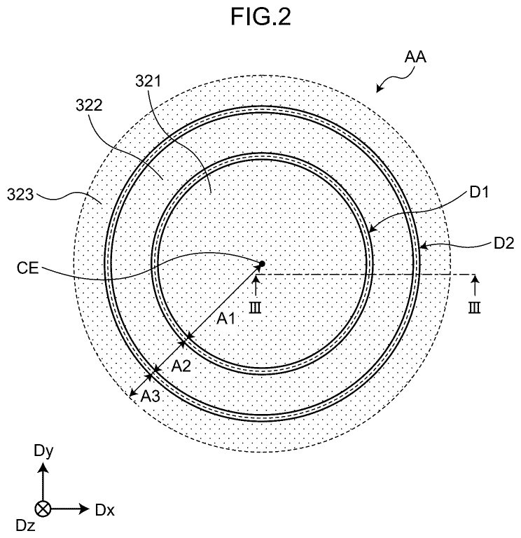

FIG. 2 is a plan view illustrating a schematic structure in the light-transmitting region AA. The light-transmitting region AA includes a plurality of concentric circular regions with reference to the circle center of the light-transmitting region AA. FIG. 2 illustrates an example in which three concentric circular regions of a first region A1, a second region A2, and a third region A3 are provided, but this is merely exemplary. The number of concentric circular regions may be two or may be equal to or greater than four. The concentric circular regions include the circular region (the first region A1) and one or more annular regions (for example, the second region A2 and the third region A3). The first region A1 is a circular region positioned at the center. The one or more annular regions are provided outside the circular region (first region A1) in the radial direction of the light-transmitting region AA and surround the circular region. Hereinafter, the radial direction means the radial direction of the circle of the light-transmitting region AA unless otherwise stated. In addition, a concentric circular region means any of the circular region and the annular regions.

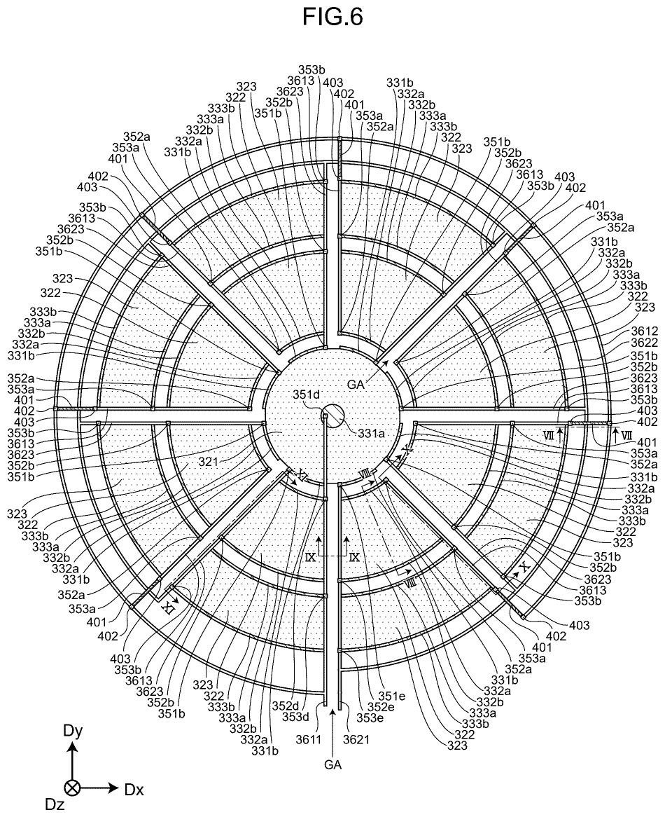

FIG. 3 is a virtual sectional view with one end near the center CE of the light-transmitting region AA and the other end at the outer peripheral end of the light-transmitting region AA. This virtual sectional view is intended to indicate a relative arrangement order of components between one end and the other end among their arrangement orders for achieving electric characteristics of the liquid crystal panel 100. In FIG. 2, section III-III is arbitrarily defined as an example of the virtual section and illustrated as a virtual sectional view in FIG. 3. In reality, the same section as the section illustrated in FIG. 3 does not necessarily occur depending on the positional relation with a first part 3613, a second part 3623, and the like (refer to FIG. 6) to be described later.

As illustrated in FIG. 3, the liquid crystal panel 100 includes a first substrate 37 and a second substrate 43 facing each other in the third direction Dz with the liquid crystal 40 interposed therebetween. The first substrate 37 and the second substrate 43 are light-transmitting substrates such as glass substrates. On the liquid crystal 40 side of the second substrate 43, an alignment film 41 and a common electrode 42 are stacked in the stated order from the liquid crystal 40 side toward the second substrate 43 side. The alignment film 41 is an insulating layer having grooves formed in the surface on the liquid crystal 40 side. The grooves define initial alignment of liquid crystal molecules contained in the liquid crystal 40. The common electrode 42 is an electrode covering the entire light-transmitting region AA.

On the liquid crystal 40 side of the first substrate 37, an alignment film 31, a high-resistance film layer 32, an electrode layer 33, and a transmission part layer 36 are stacked in the stated order from the liquid crystal 40 toward the first substrate 37 side. The alignment film 31 is an insulating layer having grooves formed in the surface on the liquid crystal 40 side. The grooves define the initial alignment of the liquid crystal molecules contained in the liquid crystal 40. The high-resistance film layer 32 has a relatively high electric resistance as compared to the common electrode 42 and the electrode layer 33 but is a film layer (high-resistance film) that functions as an electric conductor. Specifically, the high-resistance film layer 32 is formed of ITO/SiO₂. Specifically, the electric resistance value of the high-resistance film layer 32 determined in the range of 10⁶ ohm-meter (Ω/m²) to 10⁸ Ω/m² inclusive, for example.

The high-resistance film layer 32 is individually provided in each of the above-described concentric circular regions. For example, as illustrated in FIGS. 2 and 3, the high-resistance film layer 32 includes a first high-resistance film 321 provided in the first region A1, a second high-resistance film 322 provided in the second region A2, and a third high-resistance film 323 provided in the third region A3. The circles of the outer periphery edges of the first region A1, the second region A2, and the third region A3 have the same center at the center CE. In other words, the first region A1, the second region A2, and the third region A3 are a plurality of concentric circular regions having the circular outer peripheries with the same center. As illustrated in FIG. 2, the first high-resistance film 321 has a substantially circular shape in a plan view. The second high-resistance film 322 has an annular shape surrounding the first high-resistance film 321. The third high-resistance film 323 has an annular shape surrounding the second high-resistance film 322.

A spacing is provided between concentric circular regions adjacent to each other in the radial direction among the concentric circular regions. FIGS. 2 and 3 exemplarily illustrate a spacing D1 between the first region A1 and the second region A2 and a spacing D2 between the second region A2 and the third region A3. The number of such spacings is a value obtained by subtracting one from the number of the concentric circular regions. The spacings are provided in the high-resistance film layer 32 and the electrode layer 33.

In the embodiment, among the concentric circular regions, the outer concentric circular region has a smaller width in the radial direction. According to the widths of these concentric circular regions, among the high-resistance films of the high-resistance film layer 32, the high-resistance film located in the outer concentric circular region has a smaller width in the radial direction.

The electrode layer 33 is a film layer that functions as an electric conductor. Specifically, the electrode layer 33 and the common electrode 42 are formed from thin light-transmitting conductive films of, for example, indium tin oxide (ITO) or indium zinc oxide (IZO) but may be formed of an extremely highly conductive non-light-transmitting material such as copper or aluminum.

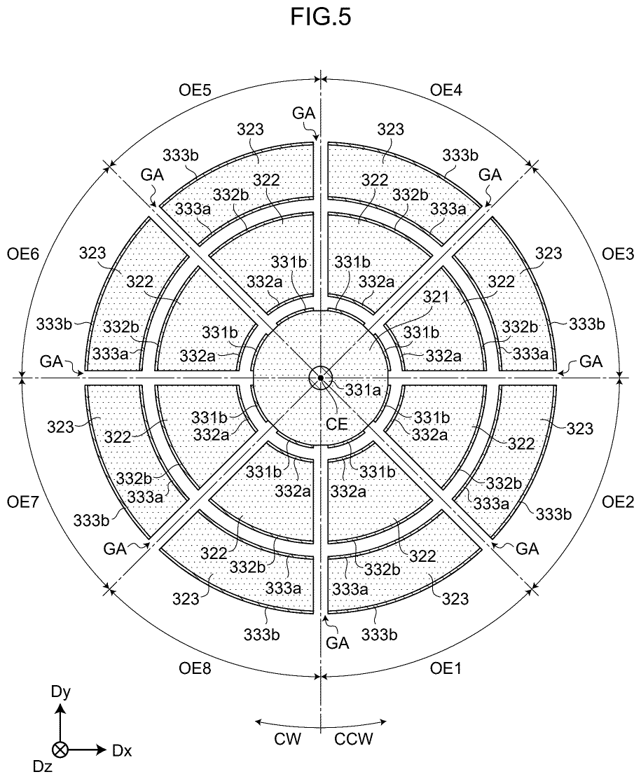

As illustrated in FIG. 3 and FIG. 5 to be described later, the electrode layer 33 includes a first electrode 331a, a second electrode 331b, a first electrode 332a, a second electrode 332b, a first electrode 333a, and a second electrode 333b. The first electrode 331a is provided overlapping the center CE (refer to FIG. 5) of the first high-resistance film 321. The shape of the first electrode 331a in a plan view is, for example, a circular shape but may be a point or polygonal shape.

The second electrode 331b is provided in an area overlapping the first high-resistance film 321 along the outer periphery of the first high-resistance film 321. The first electrode 332a is provided in an area overlapping the second high-resistance film 322 along the inner periphery of the second high-resistance film 322. The second electrode 332b is provided in an area overlapping the second high-resistance film 322 along the outer periphery of the second high-resistance film 322. The first electrode 333a is provided in an area overlapping the third high-resistance film 323 along the inner periphery of the third high-resistance film 323. The second electrode 333b is provided in an area overlapping the third high-resistance film 323 along the outer periphery of the third high-resistance film 323. As described in detail later, the shapes of the second electrode 331b, the first electrode 332a, the second electrode 332b, the first electrode 333a, and the second electrode 333b in a plan view are, for example, circular arcs in the exemplary illustration in FIG. 5.

As illustrated in FIGS. 3 and 5, the first electrode 331a and the second electrode 331b are separated from each other in the radial direction. The first electrode 332a and the second electrode 332b are separated from each other in the radial direction. The first electrode 333a and the second electrode 333b are separated from each other in the radial direction.

The high-resistance film layer 32 and the electrode layer 33 are coupled to each other through contacts formed where the high-resistance film layer 32 and the electrode layer 33 overlap. FIG. 3 exemplarily illustrates contacts 380 coupling the third high-resistance film 323 and the second electrode 333b. The contacts 380 are formed in a coupling part layer 38. The coupling part layer 38 is a part of the high-resistance film layer 32 and a part of the high-resistance film layer 32 on the electrode layer 33 side.

In the embodiment, among the contacts formed at the positions where the high-resistance film layer 32 and the electrode layer 33 overlap each other, only a contact coupling the first high-resistance film 321 and the first electrode 331a has a point-like shape whereas the other contacts have full ring shapes.

The transmission part layer 36 is a conductive layer overlapping a part of the electrode layer 33 in a plan view. The transmission part layer 36 is formed of an extremely highly conductive material such as copper or aluminum.

The transmission part layer 36 includes a first transmission part 361 and a second transmission part 362. The first transmission part 361 overlaps parts of components provided on the inner periphery side of the concentric circular regions of the electrode layer 33. Specifically, as illustrated in FIG. 3, the first transmission part 361 overlaps the first electrodes 331a, 332a, and 333a. The second transmission part 362 overlaps parts of components provided on the outer periphery side of the concentric circular regions in the electrode layer 33. Specifically, as illustrated in FIG. 3, the second transmission part 362 overlaps the second electrodes 331b, 332b, and 333b. Although not illustrated, the first transmission part 361 and the second transmission part 362 are coupled to power supply points each having a different potential on the other end side.

The electrode layer 33 and the transmission part layer 36 are coupled to each other through contacts formed at the positions where the electrode layer 33 and the transmission part layer 36 overlap each other. FIG. 3 exemplarily illustrates contacts 35 coupling the second electrode 333b and the second transmission part 362. The contacts 35 are formed in a coupling part layer 39. The coupling part layer 39 is a part of the electrode layer 33 and is a part of the electrode layer 33 on the transmission part layer 36 side. An insulating layer 390 is provided in a region of the coupling part layer 39 where no contacts such as the contacts 35 are provided. In addition, an insulating layer 385 is provided in a region of the electrode layer 33 where none of various electrodes such as the first electrode 331a, the second electrode 331b, the first electrode 332a, the second electrode 332b, the first electrode 333a, and the second electrode 333b are provided and in a region of the coupling part layer 38 where no contacts such as the contacts 380 are provided. The insulating layers 385 and 390 are formed of, for example, a silicon oxide (SiO) based light-transmitting material or a silicon nitride (SiN) based light-transmitting material.

Among combinations of coupling between a component included in the electrode layer 33 and a component included in the transmission part layer 36, components in combinations other than the combination of the second electrode 333b and the second transmission part 362 are coupled to each other through contacts as well. Specifically, the first transmission part 361 is coupled to the first electrodes 331a, 332a, and 333a. The second transmission part 362 is coupled to the second electrodes 331b, 332b, and 333b.

even when the electrode layer 33 and the transmission part layer 36 overlap each other in a plan view, unless a contact is provided at the position of the overlapping, coupling is not made at the position of the overlapping.

The stacking structure and the coupling relation described above with reference to FIG. 3 generate potential difference between the inner side and the outer side of the high-resistance film layer 32 in the radial direction. Specifically, the potential difference between a potential provided to the first transmission part 361 and a potential provided to the second transmission part 362 generates a potential gradient between the inner side and the outer side of the high-resistance film layer 32 in the radial direction. Accordingly, the liquid crystal molecules contained in the liquid crystal 40 are aligned in accordance with the potential gradient in each of the first region A1, the second region A2, and the third region A3 as illustrated in FIG. 3. More specifically, the alignment of the liquid crystal molecules is set by the relation between the potential gradient and a constant potential provided to the common electrode 42.

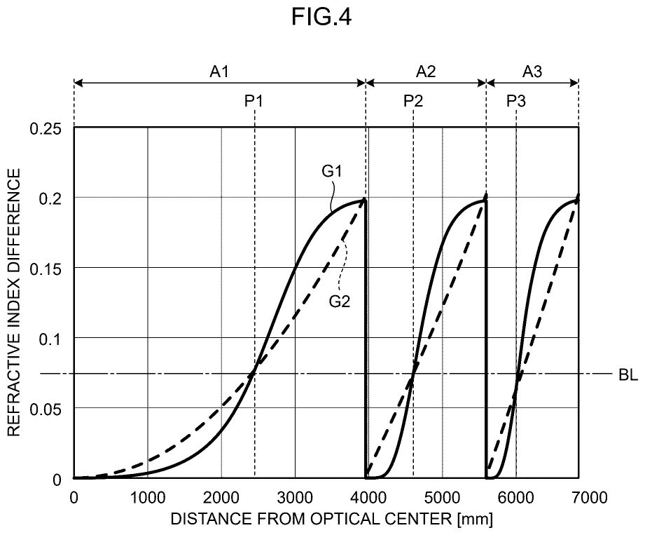

FIG. 4 is a graph illustrating the relation between the distances of the first region A1, the second region A2, and the third region A3 from an optical center and refractive index differences of light generated by the liquid crystal 40 in the state illustrated in FIG. 3 in the first region A1, the second region A2, and the third region A3. Such a refractive index difference refers to the magnitude of change in the traveling direction of light that is incident in the third direction Dz from the first substrate 37 side of the liquid crystal panel 100. The greater the degree of change of the traveling direction of light along the traveling direction while the light passes through the liquid crystal panel 100 until the light reaches the second substrate 43 side, the greater the refractive index difference. The degree of change of the traveling direction of the light refers to the degree to which the traveling direction of the light changes inwardly in the radial direction with the focal point as a center.

In the specific example, as illustrated in the graphs G1 and G2 in FIG. 4, in each of the first region A1, the second region A2, and the third regions A3, the refractive index difference decreases as the distance in the radial direction decreases; while the refractive index difference increases as the distance in the radial direction increases. In the specific example, the refractive index difference is controlled such that the refractive index difference increases from the inner side to the outer side in the radial direction in a single concentric circular region, but at the boundary from one concentric circular region to another, the refractive index difference is reset to zero at the innermost periphery of the other concentric circular region. The refractive index difference in the embodiment is closer to that illustrated in the graph G2.

When the potential difference between the potential provided to the first transmission part 361 and the potential provided to the second transmission part 362 is controlled so that the refractive index difference described above with reference to FIG. 4 is achieved, each concentric circular region of the liquid crystal panel 100 produces such an optical effect similar to that of a lens, that light entering from below in the third direction Dz is further directed toward the focal point at a position closer to the outer side in the radial direction. When likened to an optical effect of a lens, this optical effect may be regarded as that of a lens having a flat lower surface and a convex upper surface. In FIG. 3, dashed lines L1, L2, and L3 are illustrated to schematically indicate the optical effect. The dashed line L1 indicates an optical effect produced by controlling alignment of the liquid crystal molecules contained in the liquid crystal 40 in the first region A1. The dashed line L2 indicates an optical effect produced by controlling alignment of the liquid crystal molecules contained in the liquid crystal 40 in the second region A2. The dashed line L3 indicates an optical effect produced by controlling alignment of the liquid crystal molecules contained in the liquid crystal 40 in the third region A3. The optical effect of the concentric circular regions as schematically indicated with the dashed lines L1, L2, and L3 is the same as an optical effect produced by a Fresnel lens in effect. In other words, the liquid crystal panel 100 including the concentric circular regions operates to produce the same optical effect as that of a Fresnel lens.

The first high-resistance film 321 provided in the first region A1 corresponds to a first potential gradient forming part positioned relatively inward in the light-transmitting region AA. The third high-resistance film 323 provided in the third region A3 corresponds to a second potential gradient forming part positioned relatively outward in the light-transmitting region AA. The second high-resistance film 322 provided in the second region A2 can be said to be a second potential gradient forming part that is positioned relatively outward in the light-transmitting region AA with respect to the first high-resistance film 321. The second high-resistance film 322 can be said to be a first potential gradient forming part that is positioned relatively inward in the light-transmitting region AA with respect to the third high-resistance film 323.

The following description with reference to FIG. 6 and the subsequent drawings is given with special attention to components included in the area from the high-resistance film layer 32 to the transmission part layer 36 in the stacking structure in the section described above with reference to FIG. 3. In a sectional view of FIG. 8 and other drawings to be described later, illustration of components on the liquid crystal 40 side of the high-resistance film layer 32 is omitted, but in reality, the liquid crystal 40, the alignment film 41, the common electrode 42, and the second substrate 43 are stacked as in the configuration described above with reference to FIG. 3. In plan views of FIGS. 5 and 6 and other drawings, some components are illustrated without regard to their vertical relations for the purpose of clearly indicating positional relations in the stacking structure in a plan view, but the actual stacking order is as described above with reference to FIG. 3.

FIG. 5 is a schematic view illustrating an example of the shapes of the high-resistance film layer 32 and the electrode layer 33 described above with reference to FIG. 3 in a plan view. As described above, the first high-resistance film 321 has a circular shape in a plan view. The second high-resistance film 322 has an annular shape surrounding the first high-resistance film 321. The third high-resistance film 323 has an annular shape surrounding the second high-resistance film 322.

More specifically, the second high-resistance film 322 is a set of high-resistance films obtained by dividing a circular ring surrounding the outer periphery side of the first high-resistance film 321 in a plan view into a plurality of pieces by a plurality of gaps GA. The third high-resistance film 323 is a set of high-resistance films obtained by dividing a circular ring surrounding the outer periphery side of the second high-resistance film 322 in a plan view into a plurality of pieces by a plurality of gaps GA.

In the example illustrated in FIG. 5, eight gaps GA substantially equally divide the second high-resistance film 322 and the third high-resistance film 323 into eight pieces. The eight second high-resistance films 322 each have an arc shape. The eight second high-resistance films 322 are arranged in the circumferential direction about the center CE in a plan view and overlap the second region A2. Hereinafter, the term “circumferential direction” refers to the circumferential direction about the center CE in a plan view unless otherwise stated. The eight third high-resistance films 323 each have an arc shape. The eight third high-resistance films 323 are arranged in the circumferential direction and overlap the third region A3.

The first electrode 332a and the second electrode 332b provided on the second high-resistance film 322 also have arc shapes obtained by dividing a circular ring about the center CE into eight pieces by eight gaps GA. The eight first electrodes 332a overlap different second high-resistance films 322, respectively, along edges of the second high-resistance films 322 on the inner periphery side. The eight second electrodes 332b overlap different second high-resistance films 322, respectively, along edges of the second high-resistance films 322 on the outer periphery side.

The first electrode 333a and the second electrode 333b provided on the third high-resistance film 323 also have arc shapes obtained by dividing a circular ring about the center CE into eight pieces by eight gaps GA. The eight first electrodes 333a overlap different third high-resistance films 323, respectively, along edge of the third high-resistance films 323 on the inner periphery side. The eight second electrodes 333b overlap different third high-resistance films 323, respectively, along edges of the third high-resistance films 323 on the outer periphery side.

The second electrode 331b provided on the first high-resistance film 321 also has arc shapes obtained by dividing a circular ring about the center CE into eight pieces by eight gaps GA. The eight second electrodes 331b overlap the first high-resistance film 321 at mutually different positions along an edge of the first high-resistance film 321 on the outer periphery side. Each of the gaps GA dividing the second electrode 331b in the circumferential direction can be said to have one end in the radial direction at the same position as the inner periphery of the second electrode 331b, and the other end at the same position as the outer periphery of the second electrode 333b. The gap GA divides, on the one end side, not only the second electrode 331b but also the outer periphery of the first high-resistance film 321. However, since the one end of the gap GA in the radial direction is at the same position as the inner periphery of the second electrode 331b, the one end of the gap GA in the radial direction does not extend to the center CE. In other words, the first high-resistance film 321 is not divided.

The above description “the first high-resistance film 321 has a substantially circular shape in a plan view.” indicates that the first high-resistance film 321 has a shape in which part of its outer periphery is recessed by a plurality of gaps GA, and is circular except for the recess by the gaps GA.

The gaps GA are formed such that gaps GA adjacent to each other in the circumferential direction have a predetermined angle therebetween. The predetermined angle is an angle obtained by dividing 360° about the center CE by the number of gaps GA. The predetermined angle is 45° in a case where the number of gaps GA is eight as exemplarily illustrated in FIG. 5.

Each of the gaps GA substantially overlaps a radius with respect to the center CE, but the central line of the gap GA in the radial direction does not necessarily need to overlaps the line of the radius with respect to the center CE. In the example illustrated in FIG. 5, each of the eight gaps GA is slightly shifted in a counterclockwise direction CCW relative to the line of the radius with respect to the center CE. In the case of the example illustrated in FIG. 5, each of the eight gaps GA overlaps the line of the radius with respect to the center CE at the position of a side line in a clockwise direction CW. Such specific positions of the gaps GA in a plan view are merely exemplary, and the present disclosure is not limited thereto and their positions are changeable as appropriate.

Hereinafter, expressions of partial regions OE1, OE2, OE3, OE4, OE5, OE6, OE7, and OE8 illustrated in FIG. 5 are used in some cases for the purpose of distinguishing divided regions of the concentric circular regions divided by the gaps GA. The partial regions OE1, OE2, OE3, OE4, OE5, OE6, OE7, and OE8 are arranged in the stated order in the counterclockwise direction CCW along the circumferential direction, starting from the partial region OE1. The partial region OE1 is adjacent to the partial region OE8 on the clockwise direction CW side with one gap GA interposed therebetween in the circumferential direction.

One second high-resistance film 322, one third high-resistance film 323, one first electrode 332a, one first electrode 333a, one second electrode 331b, one second electrode 332b, and one second electrode 333b are disposed in each of the partial regions OE1, OE2, OE3, OE4, OE5, OE6, OE7, and OE8. Each of the partial regions OE1, OE2, OE3, OE4, OE5, OE6, OE7, and OE8 also includes one-eighth of the first high-resistance film 321 and one-eighth of the first electrode 331a.

As illustrated in FIG. 5, the outer peripheries of the first high-resistance film 321, the second high-resistance films 322, and the third high-resistance films 323 each form an arc. The second high-resistance films 322 are arranged in an annular manner so as to surround the first high-resistance film 321. The third high-resistance films 323 are arranged in an annular manner so as to surround the first high-resistance film 321 and the second high-resistance films 322.

The inner peripheries of the second high-resistance films 322 and the third high-resistance films 323 each form an arc. The first electrodes 332a and the second electrodes 332b are arc-shaped electrodes individually disposed on the second high-resistance films 322. The first electrodes 333a and the second electrodes 333b are arc-shaped electrodes individually disposed on the third high-resistance films 323.

The second electrodes 331b provided on the first high-resistance film 321 are a plurality of electrodes arranged in an annular manner along the outer periphery of the first high-resistance film 321.

The following describes, with reference to FIG. 6, an example of disposition of the contacts 35 described above with reference to FIG. 3 in a plan view and the shape of the transmission part layer 36 in a plan view. The description with reference to FIG. 6 will also be made on the relation between the contacts 35, the transmission part layer 36, and the high-resistance film layer 32 and the electrode layer 33 described above with reference to FIG. 5.

FIG. 6 is a schematic view illustrating an example of disposition of the contacts 35 described above with reference to FIG. 3 in a plan view and the shape of the transmission part layer 36 in a plan view. The following first describes components included in the transmission part layer 36. As described above with reference to FIG. 3, the transmission part layer 36 includes the first transmission part 361 and the second transmission part 362. In FIG. 6, a first base part 3611, a first peripheral part 3612, and the first part 3613 are each illustrated as a component corresponding to the first transmission part 361. In addition, in FIG. 6, a second base part 3621, a second peripheral part 3622, and the second part 3623 are each illustrated as a component corresponding to the second transmission part 362.

The first base part 3611 is extended along the gap GA between the partial regions OE1 and OE8 illustrated in FIG. 5. Thus, it can be understood that the gap GA between the partial regions OE1 and OE8 is a gap GA provided with the first base part 3611. The first base part 3611 illustrated in FIG. 6 overlaps end parts of “the corresponding second high-resistance film 322 and the third high-resistance film 323 provided in the partial region OE8” on the counterclockwise direction CCW side in a plan view. One end of the first base part 3611 is positioned outward from the corresponding second electrode 333b in the radial direction. The other end of the first base part 3611 is located at a position overlapping the first electrode 331a. The “potential provided to the first transmission part 361” described above with reference to FIG. 4 is provided from the one end side of the first base part 3611.

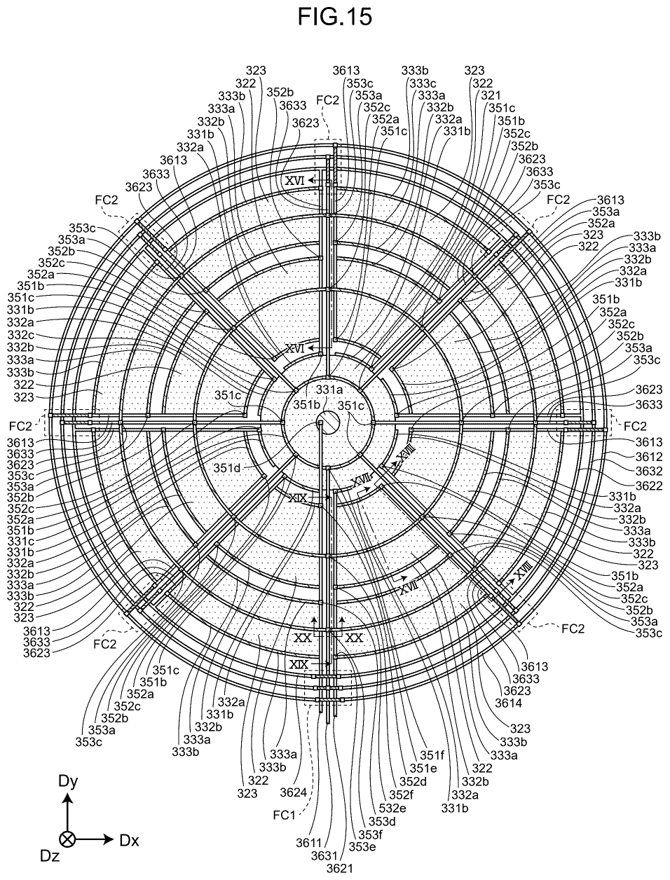

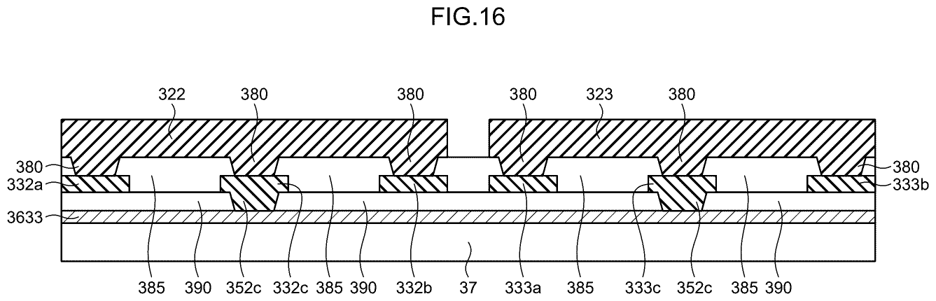

The first peripheral part 3612 is provided outward from the third high-resistance films 323 in the radial direction and extended so as to surround the light-transmitting region AA (refer to FIGS. 1 and 2). Components that are “extended so as to surround the light-transmitting region AA”, such as the first peripheral part 3612 as well as the second peripheral part 3622 and a third peripheral part 3632 (refer to FIG. 15) to be described later, are provided in the peripheral region FA (refer to FIG. 1).

The shape of the first peripheral part 3612 in a plan view, which is exemplarily illustrated in FIG. 6 and other diagrams, is an arc shape extending in the circumferential direction, but is not limited thereto and may be a polygonal shape. The first peripheral part 3612 is continuous with the first base part 3611 on the one end side. An end part of the first peripheral part 3612 on the other end side is positioned on the counterclockwise direction CCW side of the partial region OE1. Thus, when regarded as a component extending from the first base part 3611, the first peripheral part 3612 illustrated in FIG. 6 can be regarded as a conductive layer extending in the clockwise direction CW from an end part of the partial region OE8 on the counterclockwise direction CCW side to an end part of the partial region OE1 on the counterclockwise direction CCW side, so as to surround the light-transmitting region AA on the outer periphery side of the light-transmitting region AA.

The first part 3613 is extended along each gap GA in which the first base part 3611 is not provided among the gaps GA. FIG. 6 illustrates seven first parts 3613 provided along seven gaps GA, respectively, among the eight gaps GA described above with reference to FIG. 5 except for the gap GA between the partial regions OE1 and OE8.

In each of the partial regions OE2, OE3, OE4, OE5, OE6, OE7, and OE8 (refer to FIG. 5), the first part 3613 overlaps an end part of the second high-resistance film 322 on the counterclockwise direction CCW side and an end part of the third high-resistance film 323 on the counterclockwise direction CCW side. In other words, the first part 3613 is located on the clockwise direction side CW side of the gap GA along which the first part 3613 extends.

Each first part 3613 is continuous with the first peripheral part 3612 on the one end side. In other words, each first part 3613 is coupled to the first peripheral part 3612. The other end of each first part 3613 is located at a position overlapping the corresponding first electrode 332a. Thus, when regarded as a component extending from the first peripheral part 3612, each first part 3613 illustrated in FIG. 6 can be regarded as a conductive layer extending into the light-transmitting region AA up to the first electrode 332a at a position overlapping end parts of “a second high-resistance film 322 and a third high-resistance film 323 not overlapping the first base part 3611” on the counterclockwise direction CCW side.

The second base part 3621 is extended along the gap GA between the partial regions OE1 and OE8 illustrated in FIG. 5. Thus, it can be understood that the gap GA between the partial regions OE1 and OE8 is a gap GA provided with the second base part 3621. The second base part 3621 illustrated in FIG. 6 overlaps end parts of “the second high-resistance film 322 and the third high-resistance film 323 provided in the partial region OE1” on the clockwise direction CW side in a plan view. One end of the second base part 3621 is positioned outward from the corresponding second electrode 333b in the radial direction. The other end of the second base part 3621 is located at a position overlapping the corresponding second electrode 331b. The “potential provided to the second transmission part 362” described above with reference to FIGS. 3 and 4 is provided from the one end side of the second base part 3621.

The second peripheral part 3622 is provided outward from the third high-resistance films 323 in the radial direction and extended so as to surround the light-transmitting region AA (refer to FIGS. 1 and 2). The shape of the second peripheral part 3622 in a plan view, which is exemplarily illustrated in FIG. 6 and other diagrams, is an arc shape extending in the circumferential direction, but is not limited thereto and may be a polygonal shape. The second peripheral part 3622 is continuous with the second base part 3621 on the one end side. An end part of the second peripheral part 3622 on the other end side is positioned on the clockwise direction CW side of the partial region OE8. Thus, when regarded as a component extending from the second base part 3621, the second peripheral part 3622 illustrated in FIG. 6 can be regarded as a conductive layer extending in the counterclockwise direction CCW from an end part of the partial region OE1 on the clockwise direction CW side to an end part of the partial region OE8 on the clockwise direction CW side, so as to surround the light-transmitting region AA on the outer periphery side of the light-transmitting region AA.

The second part 3623 is extended along each gap GA in which the second base part 3621 is not provided among the gaps GA. FIG. 6 illustrates seven second parts 3623 provided along seven gaps GA, respectively, among the eight gaps GA described above with reference to FIG. 5 except for the gap GA between the partial regions OE1 and OE8.

In each of the partial regions OE2, OE3, OE4, OE5, OE6, OE7, and OE8 (refer to FIG. 5), the second part 3623 overlaps an end part of the second high-resistance film 322 on the clockwise direction CW side and an end part of the third high-resistance film 323 on the clockwise direction CW side. In other words, the second part 3623 is located on the counterclockwise direction side CCW side of the gap GA along which the second part 3623 extends.

One end of each second part 3623 is positioned outward from the corresponding second electrode 333b in the radial direction and inward from the first peripheral part 3612 in the radial direction. The other end of each second part 3623 is located at a position overlapping the corresponding second electrode 331b.

The first peripheral part 3612 is coupled to the one end of each first part 3613 through a coupling member 401, a contact 402, and a contact 403. In other words, each first part 3613 is coupled to the first peripheral part 3612.

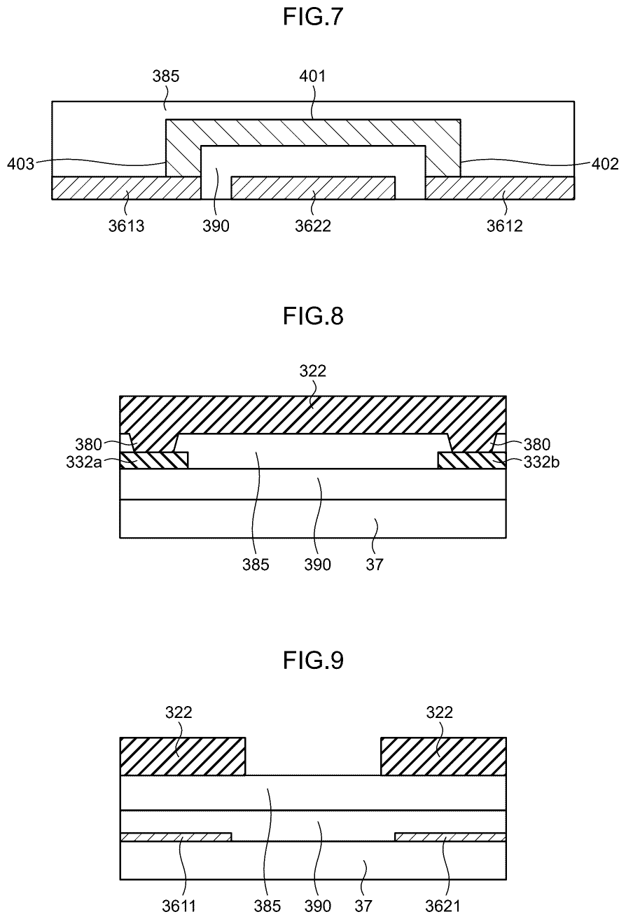

FIG. 7 is a VII-VII sectional view of FIG. 6. As illustrated in FIG. 7, the coupling member 401 is stacked on the second peripheral part 3622 with the insulating layer 390 interposed therebetween. One of opposite ends of the coupling member 401 extends to a position overlapping the first peripheral part 3612, and the other of the opposite ends extends to a position overlapping one end of the first part 3613. The contact 402 is a contact coupling the coupling member 401 and the first peripheral part 3612. The contact 403 is a contact coupling the coupling member 401 and the one end of the first part 3613.

The coupling member 401 is in the same layer as the electrode layer 33 and has the same composition as the electrode layer 33. The contacts 402 and 403 are in the same layer as the contacts 35 and have the same composition as the electrode layer 33. Thus, the coupling member 401 and the contacts 402 and 403 can be formed simultaneously with the electrode layer 33 and the contacts 35 in the same formation process. The description with reference to FIGS. 6 and 7 is made with one of the seven coupling members 401, one of the seven contacts 402, and one of the seven contacts 403, but the other six coupling members 401, contacts 402, and contacts 403 have the same structures. The coupling members 401 and the contacts 402 and 403 may be provided as a dedicated stacking structure independent from the electrode layer 33 and the contacts 35.

FIG. 8 is a VIII-VIII sectional view of FIG. 6. FIG. 8 exemplarily illustrates contacts 380 coupling the second high-resistance film 322, the first electrode 332a, and the second electrode 332b.

As described above with reference to FIGS. 3 and 4, the first transmission part 361 and the second transmission part 362 have different potentials. Thus, components corresponding to the first transmission part 361 and components corresponding to the second transmission part 362 are provided not to contact each other.

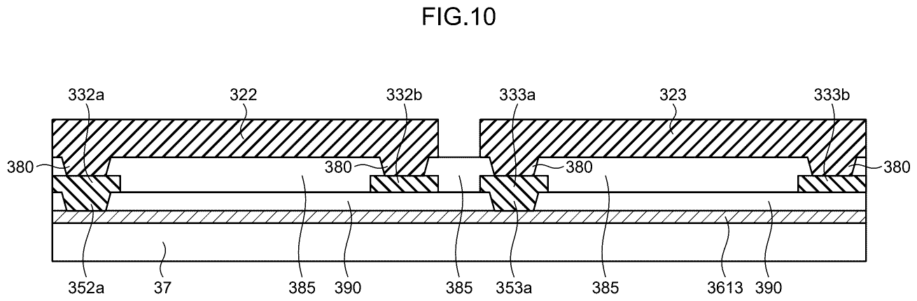

FIG. 9 is a IX-IX sectional view of FIG. 6. As illustrated in FIGS. 6 and 9, the first base part 3611 and the second base part 3621 are separated from each other with a gap GA interposed therebetween and are physically discontinuous. Coupling between the first peripheral part 3612 and the one end of each first part 3613 through the coupling member 401 and the contacts 402 and 403 described above with reference to FIG. 7 is a configuration for separating components corresponding to the first transmission part 361 from components corresponding to the second transmission part 362.

The above description is made on components included in the transmission part layer 36 in the configuration illustrated in FIG. 6. The following describes components corresponding to the contacts 35 described above with reference to FIG. 3 in the configuration illustrated in FIG. 6. In FIG. 6, contacts 352a, 353a, 351b, 352b, 353b, 351d, 352d, 353d, 351e, 352e, and 353e are illustrated as components corresponding to the contacts 35.

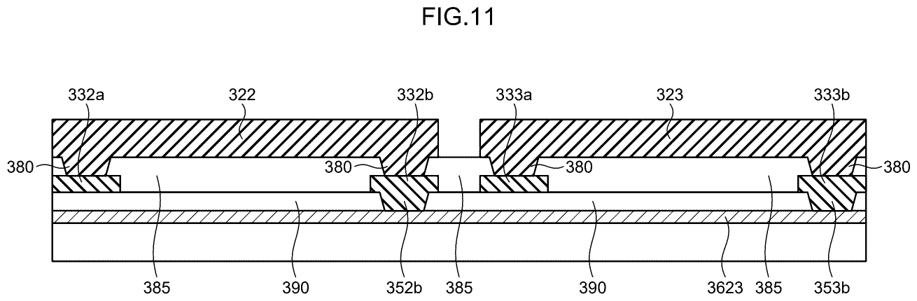

FIG. 10 is a X-X sectional view of FIG. 6. As illustrated in FIG. 10, the contact 352a is a contact coupling the first part 3613 and the first electrode 332a. To achieve such coupling, the contact 352a is located at a position overlapping the first part 3613 and the first electrode 332a in a plan view.

As illustrated in FIG. 10, the contact 353a is a contact coupling the first part 3613 and the first electrode 333a. To achieve such coupling, the contact 353a is located at a position overlapping the first part 3613 and the first electrode 333a in a plan view.

FIG. 11 is an XI-XI sectional view of FIG. 6. As illustrated in FIG. 11, the contact 352b is a contact coupling the second part 3623 and the second electrode 332b. To achieve such coupling, the contact 352b is located at a position overlapping the second part 3623 and the second electrode 332b in a plan view. As illustrated in FIG. 11, the contact 353b is a contact coupling the second part 3623 and the second electrode 333b. To achieve such coupling, the contact 353b is located at a position overlapping the second part 3623 and the second electrode 333b in a plan view.

The contacts 352a, 353a, 352b, and 353b described above with reference to FIGS. 10 and 11 are each one of seven contacts, and the other six contacts have the same structure.

Although not illustrated in FIG. 11, the contact 351b is a contact coupling the second part 3623 and the second electrode 331b. To achieve such coupling, the contact 351b is located at a position overlapping the second part 3623 and the second electrode 331b in a plan view.

Coupling between the second part 3623 and the second electrode 331b through the contact 351b is the same as coupling between the second part 3623 and the second electrode 332b through the contact 352b. Couplings through the other contacts (contacts 351d, 352d, 353d, 351e, 352e, and 353e), of which the sections are not illustrated, also have the same structure except that coupled components are different.

The contact 351d is a contact coupling the first base part 3611 and the first electrode 331a. To achieve such coupling, the contact 351d is located at a position overlapping the first base part 3611 and the first electrode 331a in a plan view.

The contact 352d is a contact coupling the first base part 3611 and the first electrode 332a. To achieve such coupling, the contact 352d is located at a position overlapping the first base part 3611 and the first electrode 332a in a plan view.

The contact 353d is a contact coupling the first base part 3611 and the first electrode 333a. To achieve such coupling, the contact 353d is located at a position overlapping the first base part 3611 and the first electrode 333a in a plan view.

The contact 351e is a contact coupling the second base part 3621 and the second electrode 331b. To achieve such coupling, the contact 351e is located at a position overlapping the second base part 3621 and the second electrode 331b in a plan view.

The contact 352e is a contact coupling the second base part 3621 and the second electrode 332b. To achieve such coupling, the contact 352e is located at a position overlapping the second base part 3621 and the second electrode 332b in a plan view.

The contact 353e is a contact coupling the second base part 3621 and the second electrode 333b. To achieve such coupling, the contact 353e is located at a position overlapping the second base part 3621 and the second electrode 333b in a plan view.

In description based on the correspondence relation between FIGS. 5 and 6, one first part 3613, one second part 3623, one contact 352a, one contact 353a, one contact 351b, one contact 352b, and one contact 353b are provided in each of the partial regions OE2, OE3, OE4, OE5, OE6, and OE7. A first part 3613, the second base part 3621, and contacts 352a, 353a, 351e, 352e, and 353e are provided in the partial region OE1. The first base part 3611, a second part 3623, and contacts 352d, 353d, 351b, 352b, and 353b are provided in the partial region OE8.

The first base part 3611 and the first parts 3613 are each stacked on one of two edges connecting the outer periphery and the inner periphery of the corresponding second high-resistance film 322 serving as a segment and the corresponding third high-resistance film 323. The second base part 3621 and the second parts 3623 are each stacked on the other of the two edges connecting the outer periphery and the inner periphery of the corresponding second high-resistance film 322 serving as a segment and the corresponding third high-resistance film 323.

In the following description, the first high-resistance film 321 is regarded as a first potential gradient forming part, and the plurality (for example, eight) of second high-resistance films 322, which described above with reference to FIGS. 5 and 6, are regarded as a second potential gradient forming part. The second high-resistance films 322 function as a plurality of segments arranged so as to surround the first potential gradient forming part. In other words, one second high-resistance film 322 is one segment. The first electrode 331a corresponds to a first electrode provided on the inner periphery side of the first potential gradient forming part. Each second electrode 331b corresponds to a second electrode provided on the inner periphery side of the first potential gradient forming part. Each first electrode 332a corresponds to a first electrode provided on the inner periphery side of a second potential gradient forming part. Each second electrode 332b corresponds to a second electrode provided on the inner periphery side of a second potential gradient forming part. The contacts 352a, 351d, and 352d correspond to first contacts coupling these first electrodes and the first transmission part 361. The contacts 351b, 352b, 351e, and 352e correspond to second contacts coupling these second electrodes and the second transmission part 362. A plurality (for example, eight) of first base parts 3611 correspond to a plurality of first parts stacked on the first electrodes provided on the first high-resistance film 321 and the respective second high-resistance films 322. A plurality (for example, eight) of second base parts 3621 correspond to a plurality of second parts stacked on the second electrodes provided on the first high-resistance film 321 and the respective second high-resistance films 322.

In the above description, the first high-resistance film 321 is regarded as a first potential gradient forming part, and the plurality (for example, eight) of second high-resistance films 322 described above with reference to FIGS. 5 and 6 are regarded as a second potential gradient forming part, but components corresponding to first electrodes, second electrodes, first contacts, and second contacts can also be defined in the same manner by regarding each second high-resistance film 322 as a first potential gradient forming part and regarding the plurality (for example, eight) of third high-resistance films 323 described above with reference to FIGS. 5 and 6 as a second potential gradient forming part.

When a resistance ratio is defined as the effective value of the difference in electric resistance between the inner and outer periphery sides of the circular or annular high-resistance film layer 32 in one concentric circular region, the resistance ratio is affected by not only a first resistance but also a second resistance. The first resistance is the electric resistance generated between the inner and outer periphery sides of the high-resistance film layer 32 due to the width of the high-resistance film layer 32 in the radial direction, and the second resistance is the electric resistance of the electrode layer 33 corresponding to the circumferential length of the concentric circular region where the high-resistance film layer 32 is provided. Specifically, the resistance ratio corresponds to a value obtained by dividing the first resistance by the second resistance. The resistance ratio needs to exceed 100 and is desirably 1000 approximately. To achieve such a resistance ratio, it is often desirable that the first resistance be larger and the second resistance be smaller. However, the width of the high-resistance film layer 32 in the radial direction decreases in the outer concentric circular region, and thus it is more difficult to ensure the first resistance in the outer concentric circular region. Thus, in the embodiment, the high-resistance film layer 32 outside the first region A1 is divided into a plurality of segments (for example, the second high-resistance films 322), and each segment is provided with a first electrodes (for example, first electrode 332a), a second electrode (for example, second electrode 332b), a first part (first part 3613), and a second part (second part 3623), whereby the second resistance of each segment is lower as compared to the second resistance of the high-resistance film layer 22 that is continuous in an annular shape. This ensures the resistance ratio of the high-resistance film layer 32 outside the first region A1 in the embodiment. Thus, a potential gradient for functioning the optical device 1 as a liquid crystal lens can be more reliably formed.

If the resistance ratio significantly exceeds 1000, the voltage gradient becomes less steep, making it difficult to produce the refractive index difference described above with reference to FIG. 4, and thus the resistance ratio is desirably 1000 approximately.

As describe, above, according to the first embodiment, the optical device 1 includes two substrates (first substrate 37 and second substrate 43) and a liquid crystal (liquid crystal 40) sandwiched between the two substrates. A first substrate (first substrate 37) that is one of the two substrates includes a first potential gradient forming part (for example, first high-resistance film 321) positioned relatively inward in a light-transmitting region (light-transmitting region AA), a second potential gradient forming part (for example, a plurality of second high-resistance films 322) positioned relatively outward in the light-transmitting region, a first electrode (for example, first electrode 331a) provided on the inner periphery side of the first potential gradient forming part, a first electrode (for example, first electrode 332a) provided on the inner periphery side of the second potential gradient forming part, a second electrode (for example, second electrode 331b) provided on the outer periphery side of the first potential gradient forming part, a second electrode (for example, second electrode 332b) provided on the outer periphery side of the second potential gradient forming part, a first transmission part (first transmission part 361) to which one of two different potentials is provided, a second transmission part (second transmission part 362) to which the other of the two different potentials is provided, a first contact (for example, contact 351d) coupling the first transmission part and the first electrode (for example, first electrode 331a) provided on the inner periphery side of the first potential gradient forming part, a first contact (for example, contact 352a or 351d) coupling the first transmission part and the first electrode (for example, first electrode 332a) provided on the inner periphery side of the second potential gradient forming part, a second contact (for example, contact 351b or 351e) coupling the second transmission part and the second electrode (for example, second electrode 331b) provided on the outer periphery side of the first potential gradient forming part, and a second contact (for example, contact 352b or 352e) coupling the second transmission part and the second electrode (for example, second electrode 332b) provided on the outer periphery side of the second potential gradient forming part. The first potential gradient forming part and the second potential gradient forming part are each made of an electric conductor having a higher electric resistance than those of the first electrode and the second electrode. The second potential gradient forming part includes a plurality of segments (for example, second high-resistance films 322) arranged so as to surround the first potential gradient forming part. The first transmission part includes a plurality of first parts (first parts 3613) coupled to the first electrodes (for example, first electrodes 332a) provided to the respective segments. The second transmission part includes a plurality of second parts (second parts 3623) coupled to the first potential gradient forming part and the second electrodes provided to the respective segments. Accordingly, potential can be provided from a plurality of places through the first parts and the second parts to the second potential gradient forming part. The second potential gradient forming part is relatively positioned on the outer periphery side, and therefore the total extension length of the first electrodes (for example, first electrode 332a) and the second electrodes (for example, second electrode 332b) provided to the second potential gradient forming part is relatively longer than the total extension length of the first and second electrodes provided to the first potential gradient forming part. Thus, the potential gradient in the second potential gradient forming part can be more reliably formed as compared to a case where power is supplied to only a single point of the entire second potential gradient forming part.

Moreover, the first transmission part (first transmission part 361) includes a first peripheral part (first peripheral part 3612) provided in a peripheral region (peripheral region FA) outside the light-transmitting region (light-transmitting region AA), the first parts (first parts 3613) are coupled to the first peripheral part, the second transmission part (second transmission part 362) includes a second peripheral part (second peripheral part 3622) provided in the peripheral region, and the second parts (second parts 3623) are coupled to the second peripheral part, and thus the first parts and the second parts can be more easily provided.

Moreover, the outer peripheries of the first potential gradient forming part (for example, first high-resistance film 321) and the segments (for example, second high-resistance films 322) each form an arc, and the segments are arranged in an annular manner so as to surround the first potential gradient forming part so that the outer periphery of the second potential gradient forming part (second high-resistance films 322) is circular as a whole. Thus, it is possible to provide the second potential gradient forming part further matching the circular light-transmitting region (light-transmitting region AA).

Moreover, the inner peripheries of the segments (for example, second high-resistance films 322) each form an arc, the first electrodes (for example, first electrodes 332a) provided to the second potential gradient forming part (for example, second high-resistance films 322) are arc-shaped electrodes individually disposed in the segments, and the second electrodes (for example, second electrode 332b) provided to the second potential gradient forming part are arc-shaped electrodes individually disposed in the segments, whereby the second potential gradient forming part (second high-resistance films 322) is annular as a whole. Thus, it is possible to provide the second potential gradient forming part further matching the circular light-transmitting region (light-transmitting region AA).

Moreover, the first parts (first parts 3613) are each overlaps one of two edges connecting the outer periphery and the inner periphery of the corresponding segment (for example, second high-resistance film 322), and the second parts (second parts 3623) each overlap the other of the two edges. Thus, the first and second parts have a linear shape, which makes it possible to establish a potential transmission mechanism with a simpler structure.

Moreover, the outer periphery of the first potential gradient forming part (for example, first high-resistance film 321) forms an arc, the second electrodes (for example, second electrodes 331b) provided to the first potential gradient forming part are a plurality of electrodes arranged in an annular manner along the outer periphery of the first potential gradient forming part, and the number of the second parts (second parts 3623) and the number of the second contacts coupling the second parts and the electrodes (for example, the total number of the contacts 351b and 351e) correspond to the number of the electrodes, whereby it is possible to further stabilize potential of the entire outer periphery side of the first potential gradient forming part, the peripheral length of which is longer than that of the inner periphery side of the first potential gradient forming part. Thus, a potential gradient can be more reliably formed.

### Second Embodiment

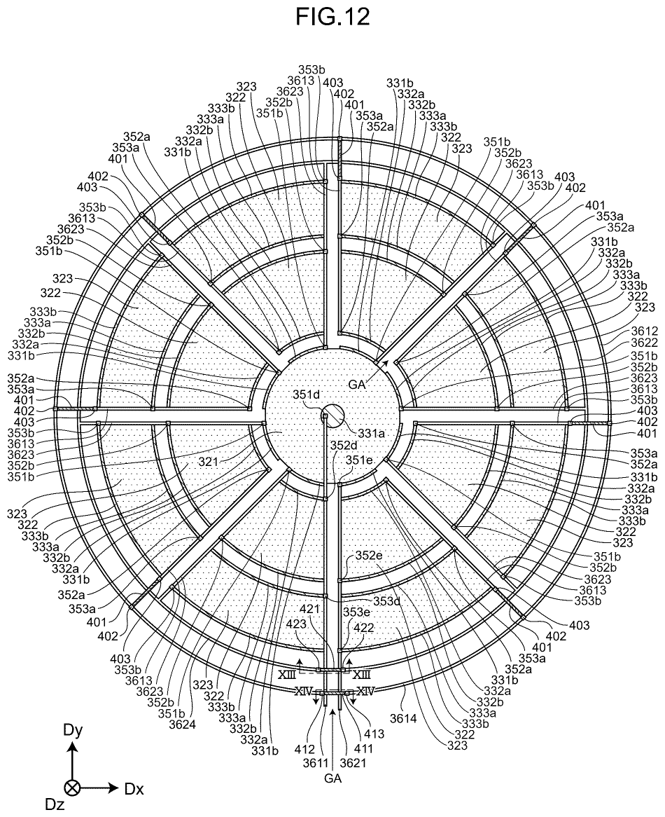

The following describes a second embodiment, which is partially different from the first embodiment, with reference to FIGS. 12 to 14. In description of the second embodiment, the same components as in the first embodiment are denoted by the same reference signs and description thereof is omitted.

FIG. 12 is a schematic view illustrating an example of disposition of the contacts 35 in a plan view and the shape of the transmission part layer 36 in a plan view in the second embodiment. In the second embodiment, a first extended end part 3614 is provided as a component corresponding to the first transmission part 361, in addition to the first base part 3611, the first peripheral part 3612, and the first parts 3613 as in the first embodiment. Moreover, in the second embodiment, a second extended end part 3624 is provided as a component corresponding to the second transmission part 362, in addition to the second base part 3621, the second peripheral part 3622, and the second parts 3623 as in the first embodiment.

The first extended end part 3614 is an arc-shaped conductive layer further extending in the clockwise direction CW from the other end of the first peripheral part 3612. The first peripheral part 3612 and the first extended end part 3614 are concentric. The first extended end part 3614 can be regarded as an extended part of the first peripheral part 3612 as compared to the first embodiment. The first extended end part 3614 has an extended end at a position separated from the second base part 3621 to such an extent that no mutual electric interaction occurs between the first transmission part 361 and the second transmission part 362, the position being as close to the second base part 3621 as possible.

The first extended end part 3614 is coupled to the first base part 3611 or a base end of the first peripheral part 3612 located on the first base part 3611 side through a coupling member 411, a contact 412, and a contact 413.

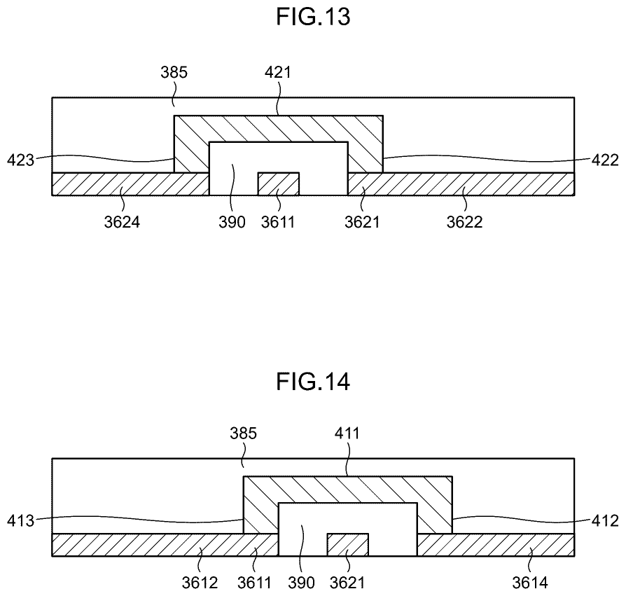

FIG. 13 is a XIII-XIII sectional view of FIG. 12. As illustrated in FIG. 13, a coupling member 421 is stacked on the first base part 3611 with the insulating layer 390 interposed therebetween. One of opposite ends of the coupling member 421 extends to a position overlapping the second extended end part 3624, and the other of the opposite ends extends to at least a position overlapping the second base part 3621. A contact 423 is a contact coupling the coupling member 421 and the second extended end part 3624. A contact 422 is a contact coupling the coupling member 421 and the second base part 3621 or the second peripheral part 3622.

The second extended end part 3624 is an arc-shaped conductive layer further extending in the counterclockwise direction CCW from the other end of the second peripheral part 3622. The second peripheral part 3622 and the second extended end part 3624 are concentric. The second extended end part 3624 can be regarded as an extended part of the second peripheral part 3622 as compared to the first embodiment. The second extended end part 3624 has an extended end at a position separated from the first base part 3611 to such an extent that no mutual electric interaction occurs with the first transmission part 361, the position being as close to the first base part 3611 as possible.

The second extended end part 3624 is coupled to the second base part 3621 or a base end of the second peripheral part 3622 located on the second base part 3621 side through the coupling member 421, the contact 422, and the contact 423.

FIG. 14 is a XIV-XIV sectional view of FIG. 12. As illustrated in FIG. 14, the coupling member 411 is stacked on the second base part 3621 with the insulating layer 390 interposed therebetween. One of opposite ends of the coupling member 411 extends to a position overlapping the first extended end part 3614, and the other extends to at least a position overlapping the first base part 3611. The contact 412 is a contact coupling the coupling member 411 and the first extended end part 3614. The contact 413 is a contact coupling the coupling member 411 and the first base part 3611 or the first peripheral part 3612.

In the second embodiment, the coupling members 411 and 421 are in the same layer as the electrode layer 33, for example, and have the same composition as the electrode layer 33. The contacts 412, 413, 422, and 423 are in the same layer as the contacts 35, for example, and have the same composition as the electrode layer 33.

The second embodiment is the same as the first embodiment except for the matters specified above. In the second embodiment, the coupling member 411 and the contacts 412 and 413 function as a first coupling member extending over the second base part 3621 of the second transmission part 362 and coupling the first extended end part 3614, which is an extended end of the first peripheral part 3612, and the first base part 3611 or the base end of the first peripheral part 3612 located on the first base part 3611 side. The coupling member 421 and the contacts 422 and 423 function as a second coupling member extending over the first base part 3611 of the first transmission part 361 and coupling the second extended end part 3624, which is an extended end of the second peripheral part 3622, and the second base part 3621 or the base end of the second peripheral part 3622 located on the second base part 3621 side.

According to the second embodiment, the first transmission part (first transmission part 361) includes a first base part (first base part 3611) extending in the peripheral region (peripheral region FA) and the light-transmitting region (light-transmitting region AA), the second transmission part (second transmission part 362) includes a second base part (second base part 3621) extending in the peripheral region and the light-transmitting region, the first peripheral part (first peripheral part 3612) extends from the first base part, the second peripheral part (second peripheral part 3622) extends from the second base part, and the liquid crystal panel 100 includes a first coupling member (coupling member 411 and contacts 412 and 413) extending over the second base part and coupling an extended end (first extended end part 3614) of the first peripheral part and the first base part or a base end of the first peripheral part located on the first base part side, and a second coupling member (coupling member 421 and contacts 422 and 423) extending over the first base part and coupling an extended end (second extended end part 3624) of the second peripheral part and the second base part or a base end of the second peripheral part located on the second base part side. With this configuration, it is possible to further stabilize the potentials of the entire first peripheral part and the entire second peripheral part. In other words, it is possible to further stabilize the potentials of the first parts (first parts 3613) extending from the first peripheral part, the first electrodes (for example, first electrodes 331a or 332a) to which potential is transmitted from the first parts, the second parts (second parts 3623) extending from the second peripheral part, the second electrodes (for example, second electrodes 331b or 332b) to which potential is transmitted from the second parts, and the first potential gradient forming part (for example, first high-resistance film 321) and the second potential gradient forming part (for example, second high-resistance films 322) in each of which a potential gradient occurs in accordance with the potential difference between the first electrode and the second electrode. Thus, a potential gradient can be more reliably formed.

### Third Embodiment

The following describes a third embodiment, which is partially different from the first and second embodiments, with reference to FIGS. 15 to 25. In description of the third embodiment, the same components as in the first and second embodiments are denoted by the same reference signs and description thereof is omitted.

FIG. 15 is a schematic view illustrating an example of disposition of the contacts 35 in a plan view and the shape of the transmission part layer 36 in a plan view in the third embodiment as well as third electrodes 331c, 332c, and 333c provided in the third embodiment.

In the third embodiment, as components included in the electrode layer 33, the third electrodes 331c, 332c, and 333c are provided in addition to the first electrodes 331a, 332a, and 333a and the second electrodes 331b, 332b, and 333b as in the first and second embodiments. Hereinafter, the phrase “additionally provided” means that one or more components are further provided in addition to the same components as in the first and second embodiments.

The third electrode 331c is an annular electrode positioned between the first electrode 331a and the second electrodes 331b in the radial direction. The third electrode 332c is an annular electrode positioned between the first electrodes 332a and the second electrodes 332b in the radial direction. The third electrode 333c is an annular electrode positioned between the first electrodes 333a and the second electrodes 333b in the radial direction.

As described above, the high-resistance film layer 32 and the electrode layer 33 are coupled to each other through contacts formed where the high-resistance film layer 32 and the electrode layer 33 overlap. Accordingly, the third electrode 331c is coupled to the first high-resistance film 321 through contacts similar to the contacts 380. The third electrode 332c is coupled to the second high-resistance films 322 through contacts similar to the contacts 380. The third electrode 333c is coupled to the third high-resistance films 323 through contacts similar to the contacts 380.

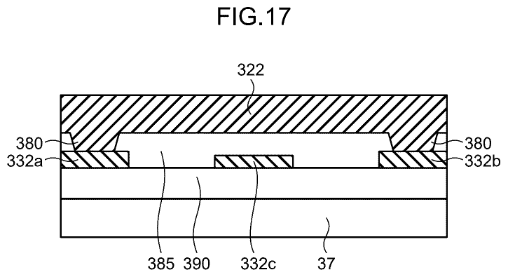

FIG. 16 is a sectional view illustrating an example of a coupling configuration between the third electrode 332c and each second high-resistance film 322 and between the third electrode 333c and each third high-resistance film 323. As illustrated in FIG. 16, in the third embodiment, the contacts 380 are formed on the electrode layer 33 side of the second high-resistance film 322 and the third high-resistance film 323 and couple the high-resistance film layer 32 and components additionally provided in the third embodiment as components included in the electrode layer 33. The relation between the third electrode 331c and the first high-resistance film 321 is omitted in illustration of FIG. 16, but is the same as the relation between the third electrode 332c and each second high-resistance film 322.

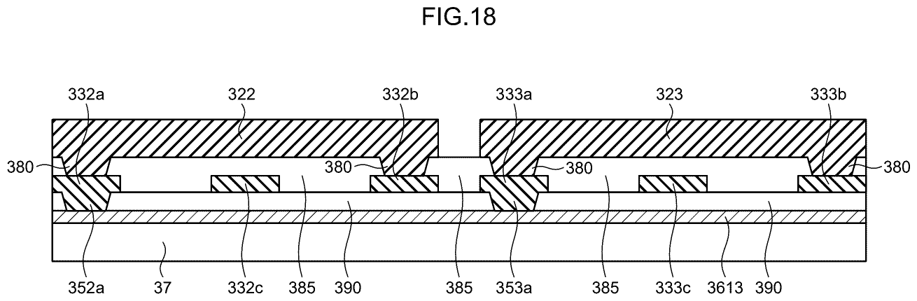

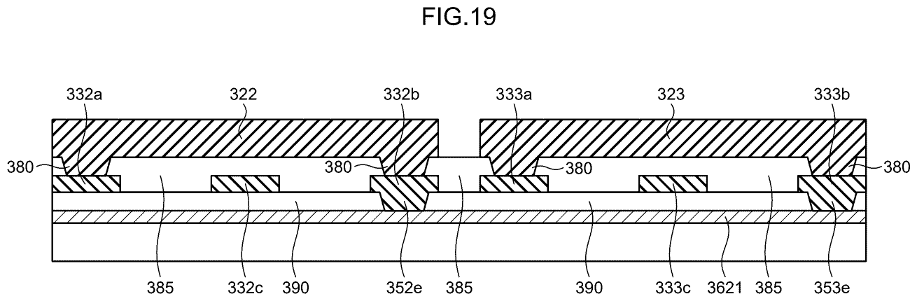

FIG. 17 is a XVII-XIVII sectional view of FIG. 15. FIG. 18 is an XVIII-XIVIII sectional view of FIG. 15. FIG. 19 is a XIX-XIX sectional view of FIG. 15. Each of the pair of the third electrode 331c and the first high-resistance film 321, the pair of the third electrode 332c and each second high-resistance film 322, and the pair of the third electrode 333c and each third high-resistance film 323 only need to be coupled to each other at least at one point and do not need to be coupled across the entire area in the circumferential direction. For example, as illustrated in FIG. 17, the third electrode 332c and each second high-resistance film 322 may not be coupled to each other. Moreover, as illustrated in FIGS. 18 and 19, there may be places where components included in the high-resistance film layer 32 are not coupled to components added as components included in the electrode layer 33 in the third embodiment, such as the third electrodes 331c, 332c, and 333c.

Specific positions of the third electrodes 331c, 332c, and 333c in the radial direction are determined in accordance with potential to be provided to the liquid crystal 40 (refer to FIG. 3) by providing the third electrodes 331c, 332c, and 333c. For example, in order to generate potential that produces alignment of the liquid crystal 40, which provides the refractive index difference of reference BL illustrated in FIG. 4, the third electrode 331c is provided at position P1, the third electrode 332c is provided at position P2, and the third electrode 333c is provided at position P3. This is merely exemplary and the present disclosure is not limited thereto, and the positions of third electrodes such as the third electrodes 331c, 332c, and 333c may be freely set between the inner and outer peripheries of the high-resistance film layer 32 provided in each of the concentric circular regions such as the first region A1, the second region A2, and the third region A3 described above with reference to FIG. 2. Thus, the correspondence relation between the potentials and disposition of the third electrodes needs to be held so that the desired refractive index difference can be achieved. Such potentials of the third electrodes are each provided from one end side of a third base part 3631 to be described later.

In the third embodiment, the third base part 3631, the third peripheral part 3632, and a third part 3633 are additionally provided as components included in the transmission part layer 36. In this example, the third base part 3631, the third peripheral part 3632, and the third part 3633 are collectively referred to as a third transmission part.

The third base part 3631 is extended along the gap GA between the partial regions OE1 and OE8 illustrated in FIG. 5. Thus, it can be understood that the gap GA between the partial regions OE1 and OE8 is a gap GA provided with the third base part 3631. The third base part 3631 illustrated in FIG. 15 is positioned between the first base part 3611 and the second base part 3621 in a plan view. One end of the third base part 3631 is positioned outward from the second electrodes 333b in the radial direction. The other end of the third base part 3631 is located at a position overlapping the third electrode 331c.

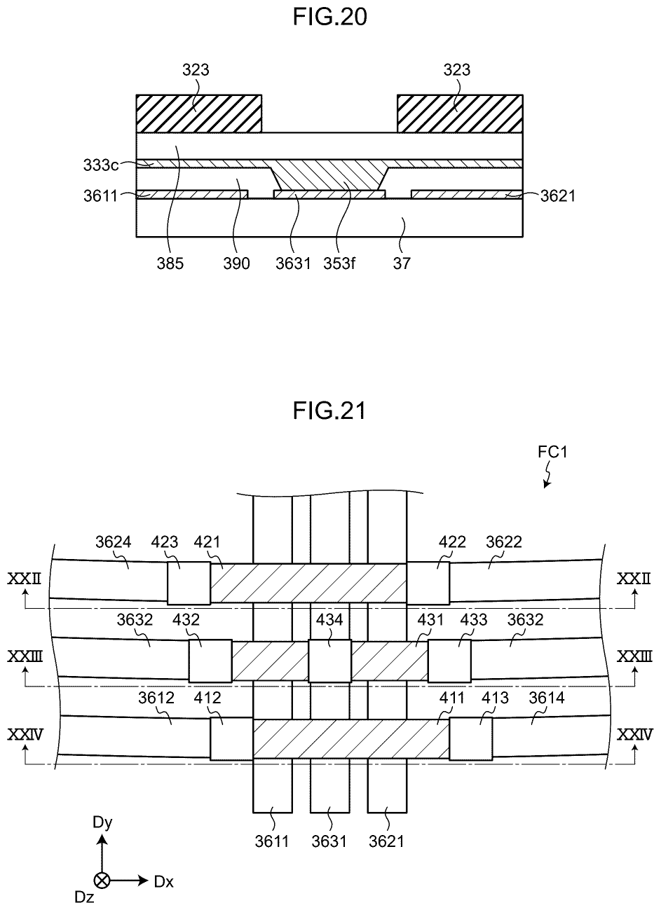

FIG. 20 is a XX-XX sectional view of FIG. 15. As illustrated in FIGS. 15 and 20, the first base part 3611, the third base part 3631, and the second base part 3621 are separated from one another and physically discontinuous. Components in part FC1 to be described later are components for separating the first base part 3611, the third base part 3631, and the second base part 3621.

The third peripheral part 3632 is provided outward from the third high-resistance films 323 in the radial direction and extended so as to surround the light-transmitting region AA (refer to FIGS. 3 and 2). The shape of the third peripheral part 3632 in a plan view, which is exemplarily illustrated in FIG. 15 and other diagrams, is an arc shape extending in the circumferential direction, but is not limited thereto and may be a polygonal shape. The opposite ends of the third peripheral part 3632 face each other with the first base part 3611, the third base part 3631, and the second base part 3621 interposed therebetween. In other words, the opposite ends of the third peripheral part 3632 are located at positions separated from the first base part 3611 and the second base part 3621 to such an extent that no mutual electric interaction occurs between the first transmission part 361 and the second transmission part 362. Moreover, one of the opposite ends of the third peripheral part 3632 is located at a position as close to the first base part 3611 as possible, and the other is located at a position as close to the second base part 3621 as possible. The third peripheral part 3632 can be regarded as a conductive layer that has the opposite ends positioned as described above and is extended from the vicinity of the end part of the partial region OE8 on the counterclockwise direction CCW side to the vicinity of the end part of the partial region OE1 on the clockwise direction CW side, so as to surround the light-transmitting region AA on the outer periphery side of the light-transmitting region AA.

The third part 3633 is extended along each gap GA in which the third base part 3631 is not provided among the gaps GA. FIG. 15 illustrates seven third parts 3633 provided along seven gaps GA, respectively, among the eight gaps GA described above with reference to FIG. 5 except for the gap GA between the partial regions OE1 and OE8.

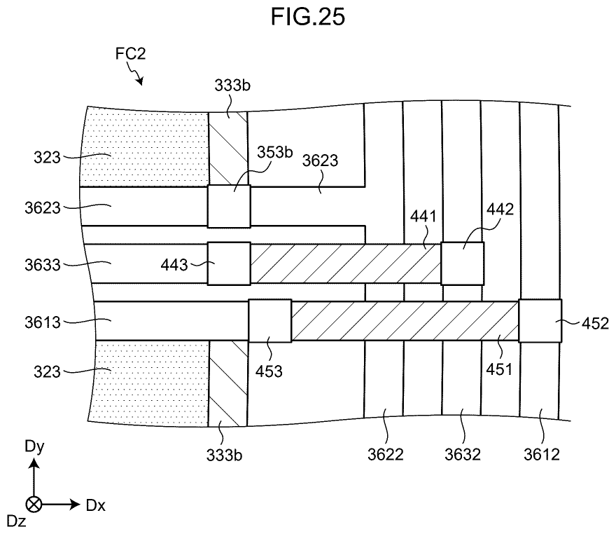

Each third part 3633 along one gap GA is positioned between a first part 3613 and a second part 3623 along the one gap GA. One end of each third part 3633 is positioned, for example, outward from the corresponding second electrode 333b in the radial direction and inward from the first peripheral part 3612 in the radial direction. The other end of each third part 3633 is located at a position overlapping the third electrode 331c. The one end of each third part 3633 and the third peripheral part 3632 are electrically coupled to each other. The coupling relation between the one end of each third part 3633 and the third peripheral part 3632 will be described later with reference to FIG. 25 to be described later.

In FIG. 15, contacts 351c, 352c, 353c, 351f, 352f, and 353f are additionally provided as components corresponding to the contacts 35.

Each contact 351c is a contact coupling the corresponding third part 3633 and the third electrode 331c. To achieve such coupling, the contact 351c is located at a position overlapping the third part 3633 and the third electrode 331c in a plan view.

Each contact 352c is a contact coupling the corresponding third part 3633 and the third electrode 332c. To achieve such coupling, the contact 352c is located at a position overlapping the third part 3633 and the third electrode 332c in a plan view.

The contact 353c is a contact coupling the corresponding third part 3633 and the third electrode 333c. To achieve such coupling, the contact 353c is located at a position overlapping the third part 3633 and the third electrode 333c in a plan view.

The contact 351f is a contact coupling the third base part 3631 and the third electrode 331c. To achieve such coupling, the contact 351f is located at a position overlapping the third base part 3631 and the third electrode 331c in a plan view.

The contact 352f is a contact coupling the third base part 3631 and the third electrode 332c. To achieve such coupling, the contact 352f is located at a position overlapping the third base part 3631 and the third electrode 332c in a plan view.

The contact 353f is a contact coupling the third base part 3631 and the third electrode 333c. To achieve such coupling, the contact 353f is located at a position overlapping the third base part 3631 and the third electrode 333c in a plan view.

In description based on the correspondence relation between FIGS. 5 and 15, among the gaps GA, each of gaps GA other than the gap GA between the partial regions OE1 and OE8 is additionally provided with one third part 3633, one contact 351c, one contact 352c, and one contact 353c. The gap GA between the partial regions OE1 and OE8 is additionally provided with the third base part 3631 and the contacts 351f, 352f, and 353f.

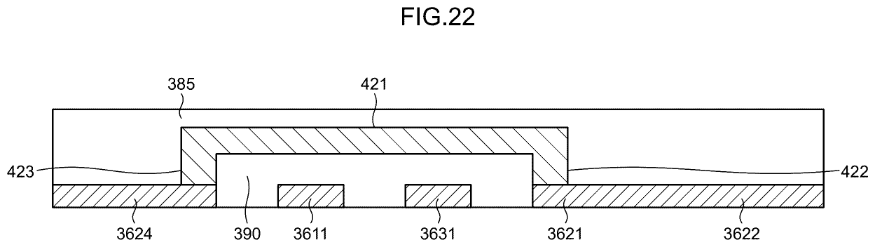

FIG. 21 is an enlarged view of part FC1 in FIG. 15. FIG. 22 is a XXII-XXII sectional view of FIG. 21. In the third embodiment, the coupling member 421 and the contacts 422 and 423 are provided as in the second embodiment. However, the coupling member 421 of the third embodiment is stacked not only on the first base part 3611 but also on the third base part 3631 with the insulating layer 390 interposed therebetween. In other words, the coupling member 421 of the third embodiment can be said to be provided so as to extend over the first base part 3611 and the third base part 3631.

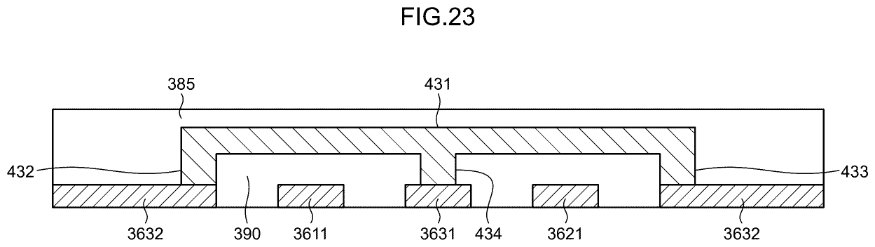

FIG. 23 is a XXIII-XXIII sectional view of FIG. 21. In the third embodiment, the opposite ends of the third peripheral part 3632 are coupled to each other through a coupling member 431, a contact 432, and a contact 433.

The coupling member 431 is stacked on the first base part 3611 and the second base part 3621 with the insulating layer 390 interposed therebetween. One of the opposite ends of the coupling member 431 extends to a position overlapping one of the opposite ends of the third peripheral part 3632. The other of the opposite ends of the coupling member 431 extends to a position overlapping the other of the opposite ends of the third peripheral part 3632. The contact 432 is a contact coupling the coupling member 431 and one of the opposite ends of the third peripheral part 3632. The contact 433 is a contact coupling the coupling member 431 and the other of the opposite ends of the third peripheral part 3632.

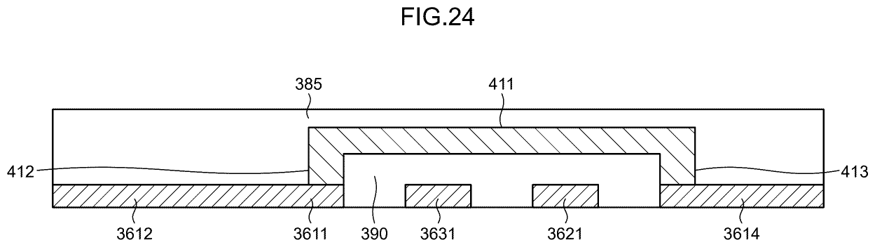

FIG. 24 is a XXIV-XXIV sectional view of FIG. 21. In the third embodiment, the coupling member 411 and the contacts 412 and 413 are provided as in the second embodiment. However, the coupling member 411 of the third embodiment is stacked not only on the second base part 3621 but also on the third base part 3631 with the insulating layer 390 interposed therebetween. In other words, the coupling member 411 of the third embodiment can be said to be provided so as to extend over the second base part 3621 and the third base part 3631.

Elements with which the contacts 352a, 353a, 351b, 352b, and 353b overlap in a plan view are the same between the first, second, and third embodiments. Accordingly, the third embodiment is the same as the first and second embodiments in terms of the electric coupling relation between elements corresponding to the first transmission part 361 and elements corresponding to the second transmission part 362. In other words, as long as the same electric coupling relation as described above can be achieved, the inner-outer relation between the first peripheral part 3612 and the second peripheral part 3622, the relation between the positions of the first parts 3613 and the positions of the second parts 3623, specific disposition of the contacts 352a, 353a, 351b, 352b, and 353b, and the like may be changed as appropriate.

FIG. 25 is an enlarged view of part FC2 in FIG. 15. One end of each third part 3633 and the third peripheral part 3632 are coupled to each other through a coupling member 441, a contact 442, and a contact 443. The coupling member 441 is stacked on the second peripheral part 3622 with the insulating layer 390 interposed therebetween. One of the opposite ends of the coupling member 441 extends to a position overlapping one end of the third part 3633. The other of the opposite ends of the coupling member 441 extends to a position overlapping the third peripheral part 3632. The contact 442 is a contact coupling the coupling member 441 and the third peripheral part 3632. The contact 443 is a contact coupling the coupling member 441 and the third part 3633.

In an exemplary configuration of the third embodiment illustrated in FIG. 15, the second peripheral part 3622 is continuous with the second parts 3623. Thus, in the exemplary configuration, the coupling member 401 and the contacts 402 and 403 described above with reference to FIG. 7 are not provided unlike the first and second embodiments. Instead, in the exemplary configuration, the first peripheral part 3612 and each first part 3613 are coupled to each other through a coupling member 451, a contact 452, and a contact 453.

The coupling member 451 is stacked on the second peripheral part 3622 and the third peripheral part 3632 with the insulating layer 390 interposed therebetween. One of the opposite ends of the coupling member 451 extends to a position overlapping one end of the first part 3613. The other of the opposite ends of the coupling member 451 extends to a position overlapping the first peripheral part 3612. The contact 452 is a contact coupling the coupling member 451 and the first peripheral part 3612. The contact 453 is a contact coupling the coupling member 451 and the first part 3613.

In the third embodiment, the coupling members 431, 441, and 451 are in the same layer as the electrode layer 33, for example, and have the same composition as the electrode layer 33. The contact 432, 433, 442, 443, 452, and 453 are in the same layer as the contacts 35, for example, and have the same composition as the electrode layer 33.

The third embodiment is the same as the second embodiment except for the matters specified above. In the example illustrated in FIG. 15, the numbers of contacts 351c, 352c, and 353c are each eight, but this is not essential. Specifically, it is sufficient to ensure the resistance ratio of the first high-resistance film 321, and it is sufficient that a necessary number of contacts are provided to stabilize the potentials of the third electrodes 331c, 332c, and 333c from the perspective of maintaining the resistance ratio of the first resistance and the second resistance within the range of the above-described condition (for example, 1000 approximately).

According to the third embodiment, the liquid crystal panel further includes a third electrode (for example, third electrode 331c) provided between each of the first electrodes (for example, first electrode 331a) and the corresponding second electrode (for example, second electrode 331b) in the first potential gradient forming part (for example, first high-resistance film 321), a third electrode (for example, third electrode 332c) provided between each of the first electrodes (for example, first electrode 332a) and the corresponding second electrode (for example, second electrode 332b) in the second potential gradient forming part (for example, second high-resistance films 322), a third transmission part (third transmission part) to which a potential between the potential of the first transmission part (first transmission part 361) and the potential of the second transmission part (second transmission part 362) is provided, and a third contact (for example, contact 351c or 352c) coupling the third electrode and the third transmission part. With this configuration, it is possible to generate a potential gradient with three potentials, namely, the potential of the first transmission part, the potential of the second transmission part, and the potential of the third transmission part. Thus, a potential gradient can be more reliably formed.

Moreover, the third electrode (for example, third electrode 332c or 333c) is annular, and therefore the potential of the annular electrode can be more easily equalized across the entire ring.

### Modifications

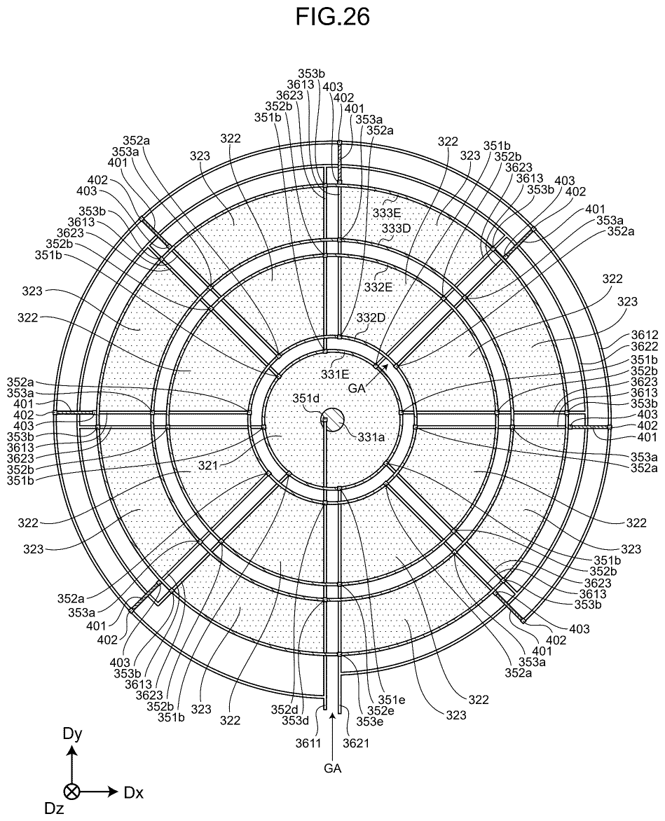

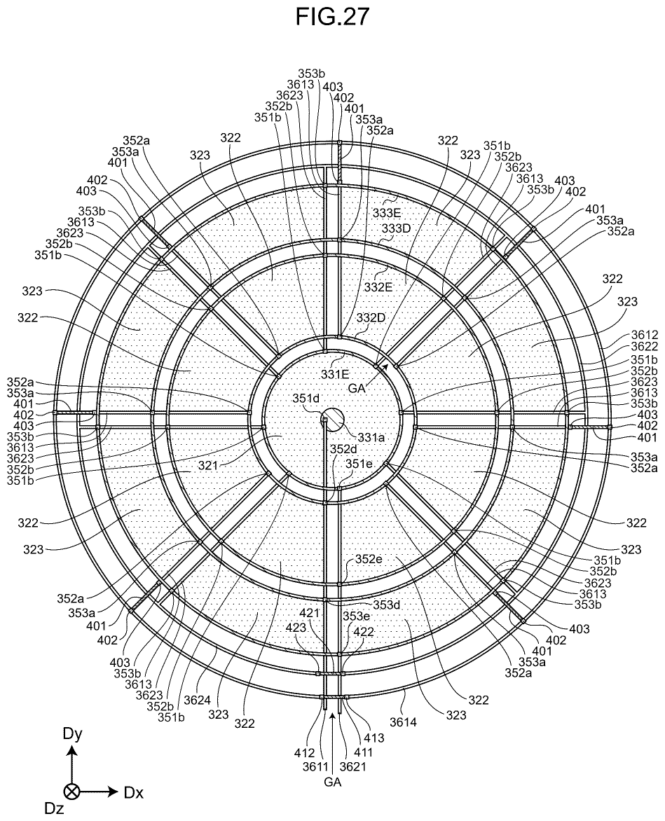

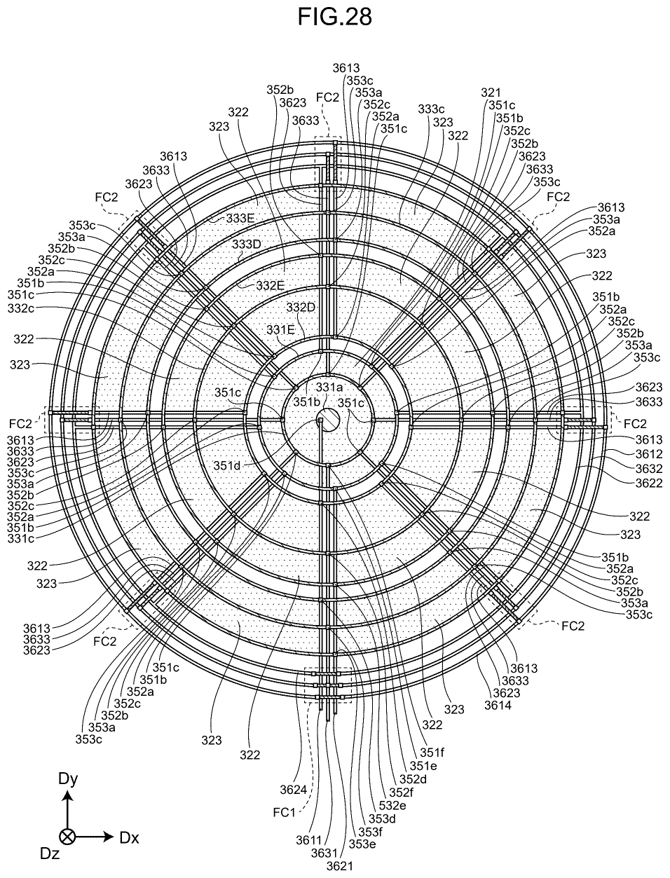

The following describes modifications partially different from the above-described embodiments with reference to FIGS. 26 to 28. FIG. 26 is a diagram illustrating a modification of the first embodiment. FIG. 27 is a diagram illustrating a modification of the second embodiment. FIG. 28 is a diagram illustrating a modification of the third embodiment.

In the modifications of the embodiments illustrated in FIGS. 26, 27, and 28, the second electrodes 331b are replaced with one second electrode 331E. Specifically, the above-described second electrodes 331b have shapes obtained by dividing one circular ring into a plurality of arc shapes by a plurality of gaps GA. In the example illustrated in FIG. 5, the number of second electrodes 331b is eight that corresponds to the eight gaps GA. However, the second electrode 331E is not divided by gaps GA but extends along the outer periphery of the first high-resistance film 321, as an annular electrode that is continuous in the circumferential direction, and overlaps the outer periphery side of the first high-resistance film 321. The outer periphery of the first high-resistance film 321 in the modifications of the embodiments is circular without the above-described recess formed by the gaps GA.

Moreover, in the modifications of the embodiments, the first electrodes 332a is replaced with one first electrode 332D. Specifically, similarly to the above-described second electrodes 331b, the above-described the first electrodes 332a have shapes obtained by dividing one circular ring into a plurality of arc shapes by a plurality of gaps GA. However, the first electrode 332D is not divided by gaps GA but extends along the inner periphery of each second high-resistance film 322, as an annular electrode that is continuous in the circumferential direction, and overlaps the inner periphery side of the second high-resistance film 322.

Moreover, in the modifications of the embodiments, the second electrodes 332b are replaced with one second electrode 332E. The second electrode 332E is not divided by gaps GA but extends along the outer periphery of each second high-resistance film 322, as an annular electrode that is continuous in the circumferential direction, and overlaps the outer periphery side of the second high-resistance film 322. Moreover, in the modifications of the embodiments, the first electrodes 333a is replaced with one first electrode 333D. The first electrode 333D is not divided by gaps GA but extends along the inner periphery of each third high-resistance film 323, as an annular electrode that is continuous in the circumferential direction, and overlaps the inner periphery side of the third high-resistance film 323. Moreover, in the modifications of the embodiments, the second electrodes 333b are replaced with one second electrode 333E. The second electrode 333E is not divided by gaps GA but extends along the outer periphery of each third high-resistance film 323, as an annular electrode that is continuous in the circumferential direction, and overlaps the outer periphery side of the third high-resistance film 323. These features related to the existence of division before and after replacement are the same as the above-described features of the relation between each first electrode 332a and the first electrode 332D.

The modification of the first embodiment illustrated in FIG. 26 is the same as the above-described first embodiment except for the matters specified above. The modification of the second embodiment illustrated in FIG. 27 is the same as the above-described second embodiment except for the matters specified above. The modification of the third embodiment illustrated in FIG. 28 is the same as the above-described third embodiment except for the matters specified above.

Not all first electrodes (first electrodes 332a and 333a) and second electrodes (second electrodes 331b, 332b, and 333b) need to be annular. For example, some of the first electrodes 332a and 333a and the second electrodes 331b, 332b, and 333b may be replaced with the annular configurations described above with reference to FIGS. 26 to 28, whereas the other electrodes may remain as a plurality of arc-shaped electrodes as described above with reference to FIGS. 1 to 25.

In the examples illustrated in FIGS. 26 to 28, the first electrodes 332D and 333D and the second electrodes 331E, 332E, and 333E are each provided with eight contacts, but this is not essential. Specifically, it is sufficient to ensure the resistance ratio of the first high-resistance film 321, and it is sufficient that contacts are provided to such an extent that the resistance ratio of the first resistance and the second resistance can be maintained within the range of the above-described condition (for example, 1000 approximately). One contact is sufficient if the condition on the resistance ratio can be satisfied with the one contact, or a larger number of contacts may be provided as appropriate if the larger number is preferable. Moreover, the number of segments is not limited to eight. Specifically, it is sufficient to ensure the resistance ratio of the high-resistance film layer 32 provided in each concentric circular region, and it is sufficient that the number of segments is set as appropriate to such an extent that the resistance ratio of the first resistance and the second resistance can be maintained within the range of the above-described condition.

According to the modifications, since at least one of the first electrodes (for example, first electrodes 332D and 333D) and the second electrodes (for example, second electrodes 331E, 332E, and 333E) is annular, the potential of the annular electrode can be more easily equalized across the entire ring.

The shape of each second potential gradient forming part (for example, second high-resistance film 322 or third high-resistance film 323) described above is an arc shape but is not limited thereto. The second potential gradient forming part may be, for example, high-resistance films that are trapezoidal in a plan view and arranged in the circumferential direction so as to surround the outer periphery of the first potential gradient forming part (for example, first high-resistance film 321). In each trapezoidal high-resistance film, the short side of the trapezoid is positioned on the inner periphery side and the long side of the trapezoid is positioned on the outer periphery side. Moreover, a first electrode (for example, first electrode 332a or 333a) and a second electrode (for example, second electrodes 332b or 333b) provided to each trapezoidal high-resistance film may be straight along two parallel sides of the trapezoid.

The liquid crystal panel 10 of the embodiments is an electrically controlled birefringence (ECB) liquid crystal panel. Thus, the direction of the initial orientation determined by the alignment film 41 and the direction of the initial orientation determined by the alignment film 31 are parallel to each other in a plan view in an antiparallel relation. However, specific aspects of the liquid crystal panel 10 such as characteristics of the alignment films 31 and 41 described above are merely exemplary and do not limit the form of the liquid crystal panel according to the present disclosure. The specific form of the liquid crystal panel may be changed as appropriate within the scope of the claims.

It should be understood that the present disclosure provides any other effects achieved by aspects described above in the present embodiment, such as effects that are clear from the description of the present specification or effects that could be thought of by the skilled person in the art as appropriate.

What is claimed is:

1. A liquid crystal panel comprising:
two substrates; and
a liquid crystal sandwiched between the two substrates, wherein
a first substrate that is one of the two substrates includes
a first potential gradient forming part positioned relatively inward in a light-transmitting region,
a second potential gradient forming part positioned relatively outward in the light-transmitting region,
a first electrode provided on an inner periphery side of each of the first potential gradient forming part and the second potential gradient forming part,
a second electrode provided on an outer periphery side of each of the first potential gradient forming part and the second potential gradient forming part,
a first transmission part to which one of two different potentials is provided,
a second transmission part to which the other of the two different potentials is provided,
a first contact coupling the first electrode and the first transmission part, and
a second contact coupling the second electrode and the second transmission part,
each of the first potential gradient forming part and the second potential gradient forming part is made of an electric conductor having a higher electric resistance than those of the first electrode and the second electrode,
the second potential gradient forming part includes a plurality of segments arranged so as to surround the first potential gradient forming part,
the first transmission part includes a plurality of first parts stacked on the first electrodes provided to the respective segments, and
the second transmission part includes a plurality of second parts stacked on the first potential gradient forming part and the second electrodes provided to the respective segments.

2. The liquid crystal panel according to claim 1, wherein
the first transmission part includes a first peripheral part provided in a peripheral region outside the light-transmitting region,
the first parts are coupled to the first peripheral part,
the second transmission part includes a second peripheral part provided in the peripheral region, and
the second parts are coupled to the second peripheral part.

3. The liquid crystal panel according to claim 2, wherein
the first transmission part includes a first base part extending in the peripheral region and the light-transmitting region,
the second transmission part includes a second base part extending in the peripheral region and the light-transmitting region,
the first peripheral part extends from the first base part,
the second peripheral part extends from the second base part, and
the liquid crystal panel includes
a first coupling member extending over the second base part and coupling an extended end of the first peripheral part and the first base part or a base end of the first peripheral part located on the first base part side, and
a second coupling member extending over the first base part and coupling an extended end of the second peripheral part and the second base part or a base end of the second peripheral part located on the second base part side.

4. The liquid crystal panel according to claim 1, wherein
outer peripheries of the first potential gradient forming part and the segments each form an arc, and
the segments are arranged in an annular manner so as to surround the first potential gradient forming part.

5. The liquid crystal panel according to claim 4, wherein
the inner peripheries of the segments each form an arc,
the first electrodes provided to the second potential gradient forming part are arc-shaped electrodes individually disposed in the segments, and
the second electrodes provided to the second potential gradient forming part are arc-shaped electrodes individually disposed in the segments.

6. The liquid crystal panel according to claim 5, wherein
the first parts are each stacked on one of two edges connecting an outer periphery and an inner periphery of a corresponding one of the segments, and
the second parts are each stacked on the other of the two edges.

7. The liquid crystal panel according to claim 1, wherein
an outer periphery of the first potential gradient forming part forms an arc,
the first potential gradient forming part is provided with a plurality of the second electrodes arranged in an annular manner along the outer periphery of the first potential gradient forming part, and
the number of the second parts and the number of the second contacts coupling the second parts and the second electrodes correspond to the number of the second electrodes.

8. The liquid crystal panel according to claim 1, further comprising:
a third electrode provided between each of the first electrodes and a corresponding one of the second electrodes in the first potential gradient forming part and the second potential gradient forming part;
a third transmission part to which a potential between the two different potentials is provided; and
a third contact coupling the third electrode and the third transmission part.

9. The liquid crystal panel according to claim 8, wherein the third electrode is annular.

10. The liquid crystal panel according to claim 1, wherein the first electrodes, the second electrodes, or both are annular.
